(19) United States
(12) Patent Application Publication
(10) Pub. No.: US 2025/0278903 A1
(43) Pub. Date: Sep. 4, 2025

(54) ARTIFICIAL INTELLIGENCE VISION SYSTEM

(71) Applicant: C3.ai, Inc., Redwood City, CA (US)

(72) Inventors: Thomas M. Siebel, Woodside, CA (US); Adrian Conrad Rami, San Francisco, CA (US); Christopher L. Chin, San Carlos, CA (US); Dinc Basar, San Francisco, CA (US); Charles W. Stabb, Walnut Creek, CA (US); Aldo Hernández, Guadalajara (MX); Thomas David Corbett, Monterey, CA (US); Casey Patrick Sedden, Redwood City, CA (US)

(73) Assignee: C3.ai, Inc., Redwood City, CA (US)

(21) Appl. No.: 19/068,634

(22) Filed: Mar. 3, 2025

Related U.S. Application Data
(60) Provisional application No. 63/561,293, filed on Mar. 4, 2024.

(51) Int. Cl. G06T 19/00; G05B 13/02; G06F 40/279; G06F 40/40

(52) U.S. Cl. CPC G06T 19/006; G05B 13/0265; G06F 40/279; G06F 40/40; G06T 2200/24; G06T 2219/024

(57) ABSTRACT

In some embodiments, an artificial intelligence vision system may be integrated with multiple enterprise software applications and the artificial intelligence vision system and method may transform the human-machine interface (HMI). The artificial intelligence vision system and method may use augmented reality, virtual reality, and/or mixed reality devices to create a new level of data interaction and collaboration for enterprise processes. Synchronization may be enabled between virtual environments presented via multiple computing devices and/or between virtual environments presented via different applications executing on the same user device. The artificial intelligence vision system and method may provide a seamless immersive and interactive experience for users by providing accurate multi-dimensional virtual environments mapped to physical environments. Enterprise insights may be generated and provided to users to enable the users to perform real-time or near real-time action regarding assets of an enterprise.

### CROSS-REFERENCES TO RELATED APPLICATIONS

This application claims priority to and the benefit of U.S. Provisional Patent Application Ser. No. 63/561,293 filed Mar. 4, 2024, the entire disclosure of which is hereby incorporated by reference in its entirety for all purposes.

### TECHNICAL FIELD

This disclosure relates generally to artificial intelligence. More specifically, this disclosure relates to a systems and methods for an artificial intelligence vision and control system.

### BACKGROUND

Enterprises often include numerous stakeholders who seek to interact with and/or manage numerous assets, both physical and digital, and the stakeholders and assets may be disparately located. Where an enterprise environment may include hundreds of different assets and/or applications and massive amounts of data from a variety of different data sources from potentially different locations, accessing these assets/applications and data is typically unintuitive and can require extensive user training and expertise. Users may have to navigate complex file systems and application interfaces to determine insights that are limited by numerous constraints. Furthermore, real-time or near real-time decision making amongst stakeholders can be difficult with limited views related to the massive amount of data associated with the assets of the enterprise.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a high-level component diagram of an illustrative system architecture according to certain embodiments of this disclosure;

FIG. 2 depicts a diagram of a synchronization handler of an artificial intelligence vision system according to some embodiments

FIG. 3 illustrates an example of a method for using an artificial intelligence vision system to generate a multi-dimensional virtual environment including one or more enterprise insights according to certain embodiments of this disclosure;

FIG. 4 illustrates an example of a method for using an artificial intelligence vision system to generate a virtual spatial environment of a physical environment;

FIG. 5 illustrates an example of a method for using an artificial intelligence vision system to execute a synchronization handler according to certain embodiments of this disclosure;

FIG. 6 illustrates an example of a method for numerous computing devices interacting with an artificial intelligence vision system;

FIG. 7 illustrates another example user interface of an artificial intelligence vision system depicting an overview of the asset including visual elements and of the globe including geospatial visual elements according to certain embodiments of this disclosure;

FIG. 8 illustrates an example user interface of an artificial intelligence vision system depicting an overview of an asset including visual elements;

FIG. 9 illustrates another example user interface of an artificial intelligence vision system depicting an overview of several assets including visual elements;

FIG. 10 illustrates another example user interface of an artificial intelligence vision system depicting an overview of a subsystem of an assets including visual elements;

FIG. 11 illustrates another example user interface of an artificial intelligence vision system depicting a detailed view of the subsystem;

FIG. 12 illustrates another example user interface of an artificial intelligence vision system depicting a detailed view of the subsystem including a chronological slider;

FIG. 13 illustrates another example user interface of an artificial intelligence vision system depicting a detailed view of the subsystem including a chronological slider;

FIG. 14 illustrates another example user interface of an artificial intelligence vision system depicting a detailed view of the subsystem;

FIG. 15 illustrates another example user interface of an artificial intelligence vision system depicting an exploded detailed view of the subsystem including visual elements;

FIG. 16 illustrates another example user interface of an artificial intelligence vision system depicting an exploded detailed view of the subsystem including visual elements;

FIG. 17 illustrates another example user interface of an artificial intelligence vision system depicting an exploded detailed view of the subsystem including visual elements;

FIG. 18 illustrates an example user interface of an artificial intelligence vision system depicting a global virtual map of maintenance and a parts inventory including visual elements;

FIG. 19 illustrates another example user interface of an artificial intelligence vision system depicting a global virtual map including an alert indicating sufficient parts for a work order;

FIG. 20 illustrates another example user interface of an artificial intelligence vision system depicting a global virtual map including an inventory view and routes including active shipments;

FIG. 21 illustrates another example user interface of an artificial intelligence vision system depicting a global virtual map including a shipment form;

FIG. 22 illustrates another example user interface of an artificial intelligence vision system depicting a three-dimensional object model library;

FIG. 23 illustrates another example user interface of an artificial intelligence vision system depicting an artificial intelligence enterprise augmented reality environment including synchronized elements in a plurality of augmented reality screens and augmented reality object-integrated images;

FIG. 24 illustrates another example user interface of an artificial intelligence vision system depicting an artificial intelligence enterprise augmented reality environment presented via a computing device according to certain embodiments of this disclosure;

FIG. 25 illustrates another example user interface of an artificial intelligence vision system depicting an artificial intelligence enterprise augmented reality environment for a supply chain artificial intelligence application presented to one or more users on computing devices according to certain embodiments of this disclosure;

FIG. 26 illustrates a diagram of data and machine learning pipelines for multi-model entity fusion according to certain embodiments of this disclosure;

FIG. 27 illustrates a graphical representation of multi-modal entity fusion according to certain embodiments of this disclosure;

FIG. 28 illustrates another example user interface of an artificial intelligence vision system depicting an artificial intelligence enterprise augmented reality environment presented via a computing device according to certain embodiments of this disclosure;

FIG. 29 illustrates another example user interface of an artificial intelligence vision system depicting an artificial intelligence enterprise augmented reality environment presented via a computing device according to certain embodiments of this disclosure;

FIG. 30 illustrates another example user interface of an artificial intelligence vision system for configuring a digital twin of an asset using one or more object models;

FIG. 31 illustrates another example user interface of an artificial intelligence vision system depicting an artificial intelligence enterprise augmented reality environment presented via a computing device according to certain embodiments of this disclosure;

FIG. 32 illustrates a diagram of an artificial intelligence vision system generating a three-dimensional virtual object using a two-dimensional schematic;

FIG. 33 illustrates another example user interface of an artificial intelligence vision system depicting a three-dimensional geospatial view and interactive interfaces with supply chain networks according to certain embodiments of this disclosure; and

FIG. 34 illustrates an example computer system according to certain embodiments.

### DETAILED DESCRIPTION

In an enterprise setting, various assets, both physical and digital, may be disparately located, stored, executed, and/or processed. In addition, various stakeholders (e.g., employees, contractors, individuals, etc.) associated with an enterprise may also be disparately located but may be tasked or desire to interact with one or more of the same assets in conjunction with one or more other stakeholders associated with the enterprise. Various information (e.g., statuses, actions, alerts, warnings, specifications, guidelines, measurements, images, videos, audio, etc.) associated with the various assets may be obtained by various systems and stored across numerous data sources in disparate data formats. Seamlessly integrating the multitude of diverse data obtained from a multitude of data sources and providing meaningful actionable visual interactions in real-time or near real-time with a multitude of assets disparately located provides a significant technical challenge to interested stakeholders. Moreover, with such potentially immense data to sort through, finding an asset quickly that needs urgent attention may seem like finding a needle in a haystack with conventional systems. A clear multi-dimensional visualization of real-world physical objects that are represented at least partially in a virtual environment that highlights alerts and/or statuses to enable an immersive interactive experience to a user is highly desirable.

Accordingly, in some embodiments, one or more technical solutions provided by the present disclosure may include an artificial intelligence vision system. The artificial intelligence vision system may be integrated with multiple enterprise software applications, and the artificial intelligence vision system may transform the human-machine interface (HMI). The artificial intelligence vision system may use augmented reality (AR), virtual reality (VR), and/or mixed reality devices to create a new level of data interaction and collaboration for enterprise processes. Conventional data presentation in enterprise software suffers from antiquated views and workflows that do not evolve with modern data challenges. The artificial intelligence vision system may provide real-time or near real-time interactive visual elements for enterprise machine-learning, generative AI, and agentic AI applications. AR and/or VR devices are employed to provide hands-on command and control of enterprise machine learning insights with historical, projected, and live real-time or near real-time visualization of data. The artificial intelligence vision system user interface may provide multiple multi-dimensional (e.g., two dimensional, three dimensional, four dimensional, etc.) visualization display elements to improve situational awareness and provide actionable control of physical objects represented by the multi-dimensional visualization display elements.

The artificial intelligence vision system may transform how data is presented, making it more interactive and intuitive. For example, the artificial intelligence vision system may include real-time data visualization to enable users to see real-time data streams like current, historical, and projected sensor readings, performance metrics, and/or machine health status overlaid on physical assets, enabling faster decision-making and proactive maintenance. An artificial intelligence vison system augmented-reality interface or multi-dimensional virtual environment (also referred to as a virtual spatial environment herein) includes multi-screen synchronization of visual elements to enable data exploration, integrated workflow execution, and collaborative use of enterprise machine learning applications, also encompassing extension of traditional flat multi-screen views to amalgamated multi-dimensional renderings of interactive visual elements. Enterprise machine learning insights may be generated by one or more computer-implemented models and provided by the artificial intelligence vision system using interactive dashboards and reports transformed into interactive multi-dimensional visualizations. The artificial intelligence vision system may enable one or more users to explore data in a more immersive and engaging way, thereby improving their efficiency interacting with enterprise assets and improving their experience using computing devices. Using the artificial intelligence vision system, multiple users and experts (e.g., masters, teachers, collaborators, etc.) can remotely guide and assist on-site workers (e.g., apprentices, students, employees, etc.) through complex tasks by sharing AR annotations and highlighting relevant information in a shared, multi-user virtual environment.

In some embodiments, the artificial intelligence vision system may be built for enterprise applications with machine learning, generative artificial intelligence, and agentic artificial intelligence-based insights. The artificial intelligence vision system may implement command and control of large-scale operations involving disparate data sources using a model-driven architecture with enterprise level safeguards and access controls. In some embodiments, the artificial intelligence vision system may transform and normalize data in disparate data formats to a standardized data format used for training one or more computer-implemented models. The artificial intelligence vision system may provide enhanced enterprise HMI functions for improving process efficiencies with enterprise machine learning and agentic artificial intelligence applications for a variety of industries including defense, aerospace, energy, agriculture, forestry, food processing, manufacturing, chemicals, life science, and others.

The artificial intelligence vision system may provide a full multi-dimensional virtual, augmented, and/or mixed reality experience for enterprise applications, among other things. Users wearing a virtual reality, augmented reality device, or mixed reality device (e.g., headset, glasses, goggles, monocle, etc.) may interact with any number of augmented reality screens (i.e., virtual screens or display areas), virtual multi-dimensional (e.g., three dimensional) surfaces, or virtual user interface elements overlaid in or anchored to a real-world physical environment. It is envisioned in this disclosure that the artificial intelligence vision system may be used by any suitable AR/VR devices having any size and form (e.g., wearable device that projects holograms). For example, the AR/VR devices may include headsets, contact lenses, implants, and/or brain computer interfaces (BCI) devices that access the visual cortex and other parts of the brain.

The AR/VR devices may include one or more processing devices and/or one or more co-processor located on a GPU to perform encoding and/or decoding. Example types of computing devices and/or processing devices used by the AR/VR devices may include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application specific integrated circuits (ASICs), field programmable gate arrays (FPGAs), or discrete circuitry.

Virtual, augmented, and/or mixed reality implementations may present display virtual elements/objects from enterprise applications overlaid at least partially on physical objects, such as a table or wall of a conference room, or the virtual elements can be rendered in any empty space. Stakeholders can simultaneously view and interact with visualized data and interfaces of the enterprise applications. The display areas can be designated for synchronized multi-user coordination with collaborative interaction of the enterprise data elements. The display areas can also be designated for asynchronous recordings of multi-user coordination with collaborative interaction of the enterprise data elements and playbacks of such recordings. Example interactive display virtual elements may include tools for time-varying data histograms, geospatial analysis, artificial intelligence driven insights and predictions, event-based exploration, and deep investigative analysis.

Each virtual screen, surface, or display area can be associated with one or more features or components of an enterprise application (e.g., an artificial intelligence application generating artificial intelligence insights). The virtual screens, surfaces, and/or display areas may include a multitude of visualizations on the same multi-dimensional globe or multiple multi-dimensional globes presented via a user interface of the artificial intelligence vision system. Although a multi-dimensional globe is discussed, any suitable virtual object may be represented in a multi-dimensional virtual environment. In one example, a first virtual screen may present a virtual globe with a first set of information (e.g., shipping lanes for cargo ships), a second virtual screen may present another virtual globe with a second set of information (e.g., locations of satellites), a third virtual screen may present a virtual representation of a vehicle (e.g., a ship) on a predicted path to a predicted destination, a fourth virtual screen may present a low-resolution satellite image feed that was used by an artificial intelligence application to predict the path and destination of the vehicle, and a fifth virtual screen can present a high-resolution video feed that was also used to predict the path and destination of the vehicle. Importantly, the artificial intelligence vision system may be configured to independently synchronize and harmonize each of the virtual screens-a feature that is not natively supported by augmented reality devices.

In another example, for predictive aircraft maintenance, an aircraft operations display area of the artificial intelligence vision system may provide a multi-dimensional view of an aircraft fleet fusing multiple visual layers in real-time or near real-time to determine the aircraft fleet's geo-position and asset health. To investigate in order to better understand the issues plaguing one or more of the aircraft, a maintenance manager can select a display virtual element of an aircraft to access aircraft details with multi-dimensional visualization of an aircraft object model and illuminate one or more degraded components based on a predicted severity of a failure mode. The severity may be predicted using various sensor measurements by one or more computer-implemented models. Overlays and alerts may inform prioritized statuses, such as a tail rudder control alert with a high risk score from a machine learning predictive maintenance machine learning model, for example.

The artificial intelligence vision system may include one or more command and control interfaces with recommended response actions for insights and predictions. For example, in response to the tail rudder control alert, the artificial intelligence vision system may present, via a user interface, the maintenance manager a recommended actions panel to send a work order to the maintenance team with a simple gesture or voice command.

The synchronization provided by the artificial intelligence vision system may allow interactions with one virtual screen or surface to be selectively and intelligently propagated to one or more of the other virtual screens or surfaces. For example, if a first user rotates the virtual globe using a first computing device, the artificial intelligence vision system may automatically trigger a rotation of a corresponding virtual globe or the rendering of a different element on the virtual globe on one or more other computing devices used by other users.

In some embodiments, data from a variety of modalities including text, images, graphics, enterprise data, telemetry, voice, signals, geo-spatial data, etc. may seamlessly managed. Interactive command and control functions executed by the artificial intelligence vision system may create new enterprise opportunities for data investigation and synchronization elements from the multi-dimensional visualizations through a variety of inputs including gestures, voice, visual, etc. The artificial intelligence vision system may execute a handler coupled to one or more enterprise machine learning applications to enable omni-modal fusion of machine learning pipelines for real-time synchronized data elements. The handler may include a synchronization module, private session module, data access rights, data overlay module, and contextual information module, among discussed herein.

In some embodiments, the artificial intelligence vision system may use digital twins as representative visualizations of real-world physical and/or digital assets. In some embodiments, stakeholders may upload a digital twin including a multi-dimensional virtual environment of a physical environment to the artificial intelligence vision system. In some embodiments, instead of digital twins, abstract representation or geospatial views may be used. In some embodiments, stakeholders may upload schematics, maps, files, etc. that include the real-world physical and/or digital assets to the artificial intelligence system, which may dynamically generate a digital twin of a multi-dimensional virtual environment using the uploads. In some embodiments, the artificial intelligence system may receive numerous data from data sources (e.g., sensors, cameras, microphones, etc.) located in a physical area and may dynamically generate a digital twin using the data to map physical assets in a multi-dimensional virtual environment.

The artificial intelligence vision system may display embedded virtual information via digital twins that represent real-time current, historical, and projected states (to account for simulations/what-if scenarios) of physical assets and/or objects associated with physical environments (e.g., manufacturing plant, hospital, airport, train station, school, office building, etc.). Further, in some embodiments, the artificial intelligence vision system may provide the ability to manipulate and interact with one or more virtual objects and/or visual elements included in the digital twins. One or more input devices (e.g., keyboard, mouse, touchpad, touchscreen, microphone, virtual retinal scanner, camera, motion sensor, etc.) may be used to receive input from the user to enable the user to interact with the digital twins. The input may include using physical limbs and/or appendages (e.g., arms, wrists, hands, fingers, etc.) with both overt and subtle gestures, such as eye gaze and eye movement (blinking, etc.), voice, BCI (e.g., thought), etc.

In some embodiments, the artificial intelligence vision system may capture the visual/physical state of real-world physical assets using sensors, cameras, and other visual tracking devices, and render such assets in a digital twin including a multi-dimensional virtual environment in real-time. Further, communication connections may be established between controllers and/or network interface cards of the real-world physical assets and the artificial intelligence vision system to enable the user to use a user interface depicting the digital twin to actually control the physical assets in real-time or near real-time. For example, a predictive maintenance enterprise insight may indicate that an actual turbine is overheating by displaying an alert associated with a turbine virtual object representing the actual turbine in the artificial intelligence vision system. A user may select the alert to drill down into the details of the alert and select to perform an action such as send a control instruction to a controller of the actual turbine to cause the turbine to modify its operation (e.g., stop or slow down).

In some embodiments, the artificial intelligence vision system may execute agentic and generative artificial intelligence to virtually generate/construct and render digital twins and virtual objects that simulate real-world assets (e.g., world foundation models). The artificial intelligence vision system may use agentic and generative artificial intelligence to contextually determine the specific information overlays, data flows, actionable steps, etc. to display/render for a specific user based on existing workflows. This may include training one or more computer-implemented models using training data including enterprise process workflows to determine the optimal methods of rendering/relaying information to the user, for example. In addition, artificial intelligence agents that automate processes, such as alert drill down and analyses may provide results, recommendations, actions, and the like that the artificial intelligence vision system agent can then display through visualizations (e.g., heuristic and/or generative) to pro-actively communicate to the user and action accordingly.

In some embodiments, enterprise machine learning applications may enable sensor and vendor-agnostic fusion. The artificial intelligence vision system capabilities may produce an open and unified repository of discoverable, accessible, traceable, and/or consumable data products. These data products may be informed by the fusion of all domain data, regardless of how the data is collected, formatted, or persisted by an upstream vendor, sensor, and/or asset. The artificial intelligence vision system may maintain a repository of high-fidelity, trustworthy, and explainable objects to enable downstream applications and analytics at a global scale, irrespective of data and/or application source. In some embodiments, the artificial intelligence vision system may provide data source agnostic and sensor agnostic fusion capability by implementing an object modeling approach that manages, analyzes, and visualizes this knowledge and information for downstream operations, intelligence, and exploitation purposes (e.g., activity-based intelligence, automated sensor orchestration, intel-ops fusion). Such techniques may include preparing, transforming, and/or persisting data in an artificial intelligence ready state to consider temporal and geo-spatial factors, detection capabilities (and confidence) of each sensor observation, environmental conditions, etc.

In some embodiments, additional technical solutions provided by the artificial intelligence vision system may include multi-user collaboration facilitated by synchronization. For example, five different users, each with their own augmented reality device, may stand around a physical table or on a cargo plane, either co-located or remotely. The artificial intelligence vision system may separately and independently render multi-dimensional virtual environments including object models for each of the different users. For example, a virtual representation of water and various ships can be rendered on top of the physical table. The artificial intelligence vision system may provide each user with their own private virtual workspace which independently renders the object models for that user based on access control rights associated with that user. Accordingly, rather than each user viewing the same multi-dimensional virtual environment including the same object model, each user can view their own multi-dimensional virtual environment including one or more unique object models.

In some embodiments, the interactions of the users can be in a virtual workspace which are synchronized or propagated to other user virtual workspaces, while other user interactions may not be synchronized or propagated. The artificial intelligence vision system may identify one or more characteristics of a user interaction and intelligently determine whether that user interaction should be reflected in the virtual workspaces of the other users. For example, a user rotating a view or perspective of a particular ship object model may automatically trigger rotation of that ship object model in one or more other user virtual workspaces. Similarly, a user selecting a particular ship object model may automatically trigger presentation of details of that ship object model (e.g., ship specifications) in that user's virtual workspace, and also automatically trigger presentation of some or all of those details in the other user virtual workspaces. Conversely, changing some parameters of the presentation (e.g., changing metric values to imperial values) may be limited to that user's virtual workspace without synchronization with the other user workspaces. Such restrictions on synchronization may be based on access control rules, among other things.

The artificial intelligence vision system may include “leader-follower” or “master-apprentice” collaboration sessions. In one example, interactions of a leader-user may be synchronized with one or more follower-users, but interactions of follower-users may not be synchronized with other users. The artificial intelligence vision system may include a synchronization handler that enables at least some of the synchronization features described herein. The synchronization handler can manage any number of data flows for any number of applications and synchronize those data flows and applications in any number of virtual display elements and/or user virtual workspaces. For example, the synchronization handler may receive low-resolution images from a satellite, high resolution images from a drone, interaction data from the user (e.g., the rotating of the first virtual globe), predictive analytics from one or more artificial intelligence applications, interaction data from one or more other users (e.g., a second user rotating the first virtual globe in the first screen which can automatically trigger rotation of the first virtual globe in the second virtual screen for some or all of the collaborative users), and the like. The synchronization handler may seamlessly integrate (or, fuse) the different data flows and intelligently harmonize the different virtual screens and/or virtual workspaces.

In some embodiments, the synchronization handler may also use enterprise access controls to determine which elements of a multi-dimensional virtual environment and which interactions should be synchronized or presented with other users. For example, multiple users may view a virtual object model of a vehicle. Users may be mechanical engineers and other users may be electrical engineers. The synchronization manager can determine which aspects of the vehicle to render for the mechanical engineers and which aspects should be rendered for the electrical engineers in the multi-dimensional virtual environment. The synchronization manager may determine that the electrical system of the vehicle should be rendered for the electrical engineers, but not the mechanical engineers. Similarly, interactions by the electrical engineers may be synchronized with virtual workspaces of other electrical engineers, but not with the mechanical engineers. Additional benefits of the disclosed techniques may use the artificial intelligence vision system to provide detailed geospatial views of property sites, buildings, and/or neighborhoods with overlay data. Also, in some embodiments the artificial intelligence vision system may generate interior three-dimensional immersive walkthroughs.

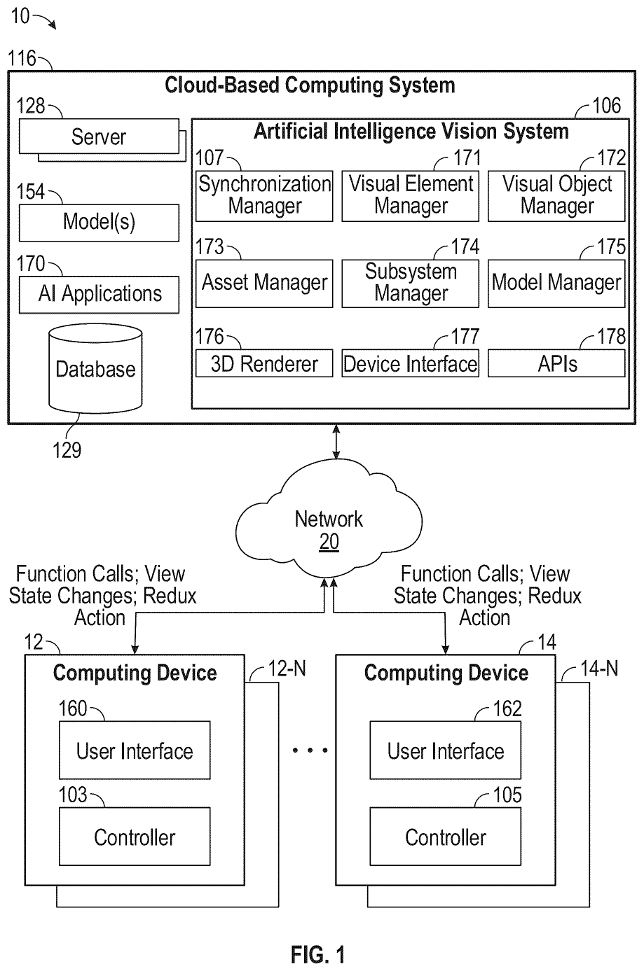

Turning now to FIG. 1, the system architecture 10 may include one or more computing devices 12-N (individually, the computing device 12, collectively, the computing devices 12-N), one or more computing devices 14-N (individually, the computing device 14, collectively, the computing devices 14-N), and a cloud-based computing system 116. In some embodiments, instead of being cloud-based, the system may be on premise and/or an air gap system (which includes one or more databases with asset libraries, subsystem libraries, virtual object libraries, visual element libraries, and the like, to load multi-dimensional virtual environment locally). The one or more computing devices 12-N and 14-N of one or more users may be communicatively coupled to the cloud-based computing system 116. Each of the computing devices 12 and 14 and components included in the cloud-based computing system 116 may include one or more processing devices, memory devices, and/or network interface cards. In some embodiments, the memory devices may store instructions that when executed by the processing devices perform any operation of any method described herein. The network interface cards may enable communication via a wireless protocol for transmitting data over short distances, such as Bluetooth, ZigBee, NFC, etc. Additionally, the network interface cards may enable communicating data over long distances, and in one example, the computing devices 12-N and 14-N and the cloud-based computing system 116 may communicate with a network 20. Network 20 may be a public network (e.g., connected to the Internet via wired (Ethernet) or wireless (WiFi)), a private network (e.g., a local area network (LAN) or wide area network (WAN)), or a combination thereof. Network 20 can comprise a node or nodes on the Internet of Things (IoT).

The computing devices 12-N and 14-N may be any suitable computing device, such as a VR device, AR device, mixed reality device, headset, goggles, BCI, glasses, contact lens, monocle, laptop computer, tablet, smartphone, wearable, or desktop computer. The computing devices 12-N may include one or more controller 103, and the computing devices 14-N may include one or more controllers 105. The controllers 103 and 105 may include one or more processing devices configured to execute instructions stored on memory devices and/or receive control instructions/data and/or transmit control instructions/data. The computing devices 12-N and 14-N may execute one or more applications (e.g., enterprise applications) and the computing devices 12-N and 14-N may include a display capable of presenting a user interface 160 and 162, respectively, of the applications. Various display areas may be concurrently presented on the user interfaces 160 and 162 for various enterprise applications. In some embodiments, the applications may be artificial intelligence (AI) applications 170 hosted by the cloud-based computing system 116 and/or downloaded from the cloud-based computing system 116. In some embodiments, the artificial intelligence applications 170 may be implemented in computer instructions stored on one or more memory devices and executed by one or more processing devices.

The cloud-based computing system 116 may execute an artificial intelligence vision system 106 that generates multi-dimensional virtual environments, among other things. The multi-dimensional virtual environments re may be presented in the user interfaces 160 and 162 and synchronized between the computing devices 12-N and/or 14-N. In some embodiments, the multi-dimensional virtual environment may present a digital twin of a physical environment. In some embodiments, the multi-dimensional virtual environment may include an empty space of any configurable color (e.g., white) with one or more virtual objects and/or physical objects included in the multi-dimensional virtual environment. Thus, the multi-dimensional virtual environment may fully or partially augmented or virtualized and represent all of or any portion of a space, room, landscape, geography, building, vehicle, machine, object, or the like.

Additionally, virtual objects and/or visual elements may be generated by one or more computer-implemented models 154. In some embodiments, the one or more virtual objects and/or visual elements presented in display areas for each respective application viewed in the user interface 160 and/or 162 may be synchronized. Synchronization between virtual environments of computing devices 12-N and 14-N may be performed via a synchronization manager 107 of the artificial intelligence vision system 106 executed by one or more servers 128 of the cloud-based computing system 116. Synchronization between visual elements and/or virtual objects of virtual environments for different applications presented via different display areas in the same user interface 160 or 162 of the computing device 12 or 14 may also be performed via the synchronization manager 107.

The artificial intelligence vision system 106 may be implemented in computer instructions stored on one or more memory devices and executed by one or more processing devices of one or more servers 128 of the cloud-based computing system 116 and/or the computing devices 12-N and/or 14-N. The artificial intelligence vision system 106 may include various components, each of which may be implemented in computer instructions stored on one or more memory devices and executed by one or more processing devices.

For example, the artificial intelligence vision system 106 may include the synchronization manager 107, a visual element manager 171, a virtual object manager 172, an asset manager 173, a subsystem manager 174, a model manager 175, a three-dimensional (3D) renderer 176, a device interface 177, and one or more application programming interfaces (APIs) 178, among other components. In some embodiments, the components may be interconnected and communicate with each other. For example, the visual element manager 171, the virtual object manager 172, the asset manager 173, the subsystem manager 174, etc. may each communicate with each other and with the synchronization manager 107. For example, if a virtual object is interacted with by a user in one multi-dimensional virtual environment presented on one computing device 12, the virtual object manager 172 may transmit data pertaining to the interaction with the virtual object (e.g., identity, type of interaction, function call, etc.) to the synchronization manager 107, and the synchronization manager 107 may encode device instructions pertaining to synchronizing the interacted with virtual object in other AI applications 170 and/or in other multi-dimensional virtual environments executing on other devices 14-N.

The visual element manager 171 may manage one or more visual elements that pertain to recommendations, results, actions, or some combination thereof. The visual elements may represent one or more enterprise insights that are generated by the one or more computer-implemented models 154. The visual elements may include various graphics or signage associated with statuses, alerts, messages, locations, parameters, values, vehicles, buildings, people, robots, machines, or some combination thereof. The visual element manager 171 may enable interacting with the one or more visual elements. The visual element manager 171 may associate the visual element with a corresponding virtual object and locate the visual element based on a location of the virtual object included in the multi-dimensional virtual environment. For example, the visual element may be located relative to, proximate to, on top of, connected to, etc. the corresponding virtual object. The visual element manager 171 may execute one or more functions associated with the visual elements when selected. For example, the one or more functions may include create, read, update, delete functions, control functions, transmission functions, and the like. Each of the various components may store data pertaining to the components in the database 129.

The virtual object manager 172 may manage one or more virtual objects that pertain to physical objects (e.g., assets, systems, subsystems, parts, buildings, vehicles, machines, robots, etc.), digital objects, digital files, software applications, AI applications 170, people, or some combination thereof. The virtual objects may be associated with one or more visual elements representing one or more enterprise insights. The virtual object manager 172 may enable interacting with the one or more virtual objects 172. For example, a user may enter input using an input device to select one of the virtual objects presented in a multi-dimensional virtual environment. In response to the input, the artificial intelligence vision system 106 may perform an action, such as presenting additional information related to the virtual object, performing a control operation associated with the virtual object, transmitting data, retrieving data, communicating with other virtual objects, and the like.

The asset manager 173 may manage (e.g., create, read, update, delete) one or more assets of an enterprise. The assets may include entities, systems, buildings, vehicles, robots, computers, and the like. The asset manager 173 may manage inventories of all the assets associated with the enterprise. For example, an asset may include a physical datacenter that includes numerous subsystems (e.g., server racks). The asset manager 173 may enable interacting with the assets presented via the multi-dimensional virtual environment. In some embodiments, the assets may be represented as virtual objects in the multi-dimensional virtual environment and one or more visual elements representing enterprise insights may be associated with those virtual elements.

The subsystem manager 174 may manage (e.g., create, read, update, delete) one or more subsystems of an enterprise. The subsystems may include parts, components, objects, files, machines, and the like. The subsystem manager 174 may manage inventories of all the subsystems associated with the enterprise. For example, a subsystem may include a physical compressor that includes numerous parts. The subsystem manager 174 may enable interacting with the subsystems presented via the multi-dimensional virtual environment. In some embodiments, the subsystems may be represented as virtual objects in the multi-dimensional virtual environment and one or more visual elements representing enterprise insights may be associated with those virtual elements.

The model manager 175 may manage one or more computer-implemented models 154. In some embodiments, the model manager 175 may train the one or more computer-implemented models 154. The computer-implemented models 154 may also be implemented in computer instructions stored on one or more memory devices and executed by one or more processing devices of one or more servers 128 of the cloud-based computing system 116 and/or the computing devices 12-N and/or 14-N.

The model manager 175 may be capable of generating the one or more computer-implemented models 154. The computer-implemented models 154 may be trained to analyze unstructured data (e.g., text, video, audio, etc.) and transform the unstructured data to structured data (e.g., normalized data) used to train the computer-implemented models 154. In some embodiments, the one or more computer-implemented models 154 may perform predictive insights and/or analysis (e.g., predictive maintenance, preventative actions, etc.) and provide recommendations, messages, alerts, statuses, etc. Any of the large language models described herein may be one of the computer-implemented models 154 that are generated and trained by the training engine 152 to perform at least some of the tasks described herein. The one or more computer-implemented models 154 may be generated by the model manager 175 and may be implemented in computer instructions executable by one or more processing devices of the model manager 175. To generate the one or more computer-implemented models 154, the model manager 175 may train the one or more computer-implemented models 154.

The model manager 175 may use a base data set of inputs (sensor measurements, video, audio, text, statuses, images, preferences, patterns, etc.) mapped to labeled outputs (recommendations, alerts, messages, actions, etc.). The outputs may include enterprise insights that are presented via the multi-dimensional virtual environment provided by the artificial intelligence vision system 106. Further, in some embodiments, the outputs from the computer-implemented models 154 may be associated with one or more virtual objects and/or visual elements presented in the multi-dimensional virtual environment.

The one or more computer-implemented models 154 may refer to model artifacts created by the model manager 175 using training data that includes training inputs and corresponding target outputs. The training engine 152 may find patterns in the training data wherein such patterns map the training input to the target output and generate the computer-implemented models 154 that capture these patterns.

Although depicted separately from the server 128, in some embodiments, the artificial intelligence vision system 106, the computer-implemented models 154, the AI applications 170, and the database 129 may reside on one or more servers 128. Further, in some embodiments, the artificial intelligence vision system 106, the computer-implemented models 154, the AI applications 170, and the database 129 may reside on the computing devices 12-N and/or 14-N.

As described in more detail below, the one or more computer-implemented models 154 may comprise, e.g., a single level of linear or non-linear operations (e.g., a support vector machine [SVM]) or the computer-implemented models 154 may be a deep network, i.e., a machine learning model comprising multiple levels of non-linear operations. Examples of deep networks are neural networks, including generative adversarial networks, convolutional neural networks, recurrent neural networks with one or more hidden layers, and fully connected neural networks (e.g., each neuron may transmit its output signal to the input of the remaining neurons, as well as to itself). For example, the machine learning model may include numerous layers and/or hidden layers that perform calculations (e.g., dot products) using various neurons. In some embodiments, the one or more computer-implemented models 154 may comprise large language models. The large language model may involve deep learning in order to understand how characters, words, and sentences function together. Deep learning involves probabilistic analysis of unstructured data, which eventually enables the deep learning model to recognize distinctions between pieces of content (e.g., words, sentences, paragraphs, documents, etc.).

The 3D renderer 176 may include instructions that create object models, texturing those objects, and adding lighting/shading/coloring to those objects in a 3D setting. The 3D renderer may include a pipeline that renders graphics by taking objects built from primitives described using vertices, and processes them to generate fragments rendered as pixels representing each 3D virtual object in a multi-dimensional virtual environment. In some embodiments, the 3D renderer renders the multi-dimensional virtual environment which may include an empty space with one or more virtual objects present in the otherwise empty space. In some embodiments the 3D renderer may generate a full digital twin multi-dimensional virtual environment of a physical environment. In some embodiments, the 3D renderer may generate partial virtual environments and augment those partial virtual environments overlaid on physical environments through a display of a computing device 12-N and/or 14-N.

The device interface 177 may enable communicatively coupling multiple computing devices 12-N and/or 14-N to each other. The device interface 177 may provide interoperability between computing devices made by different manufacturers that may be executing operating systems provided by different companies. The device interface 177 may enable agnostic operation and interaction with a shared multi-dimensional virtual environment concurrently presented via user interfaces of multiple computing devices. The device interface 177 may (i) receive commands, instructions, and/or messages from the computing devices 12-N and 14-N, (ii) translate, transform, encode, decode, etc. the commands, instructions, and/or messages from one format to another format of a target device, and (iii) transmit the transformed commands, instructions, and/or messages to the target device.

The APIs 178 may provide interfaces that connect with one or more upstream third-party applications, such as virtual object libraries, visual element libraries, operating systems for digital, virtual, and/or physical objects, and the like. The APIs 178 may enable configuring the multi-dimensional virtual environments by downloading one or more visual elements and/or virtual objects via the APIs. For example, when a new asset (e.g., factory) is acquired by an enterprise, a virtual object library that provides virtual objects representing physical objects in the new asset may be accessed via the APIs 178 to generate a multi-dimensional virtual environment of the new asset.

The AI applications (e.g., enterprise applications) 170 may be implemented in computer instructions stored on the one or more memory devices of the computing devices 12-N and/or 14-N and executable by the one or more processing devices of the computing devices 12-N and/or 14-N. The application may be hosted as a website in a web browser on the computing device or the application may be a stand-alone application installed on the computing devices 12-N and/or 14-N. The application may present various screens and/or display areas to a user via the user interfaces 160 and 162. For example, the user interface 160 may present a digital twin including a multi-dimensional virtual environment with one or more virtual objects and/or visual elements representing physical objects, enterprise insights, and the like. In some embodiments, the AI applications 170 may execute the one or more computer-implemented models 154.

The computing devices 12-N and 14-N may also include instructions stored on the one or more memory devices that, when executed by the one or more processing devices of the computing devices 12 perform operations of any of the methods described herein. In some embodiments, the cloud-based computing system 116 may include the one or more servers 128 that form a distributed computing architecture. The servers 128 may be a rackmount server, a router computer, a personal computer, a portable digital assistant, a mobile phone, a laptop computer, a tablet computer, a camera, a video camera, a netbook, a desktop computer, a media center, any other device capable of functioning as a server, or any combination of the above. Each of the servers 128 may include one or more processing devices, memory devices, data storage, and/or network interface cards. The servers 128 may be in communication with one another via any suitable communication protocol. The servers 128 may be cloud-based, be a real-time software platform, include privacy software or protocols, and/or include security software or protocols. The servers 128 may execute an artificial intelligence vision system 106 that uses one or more computer-implemented models 154 (e.g., machine learning models) to perform at least one of the embodiments disclosed herein. The one or more computer-implemented models 154 may be large language models that are used to perform at least one of the embodiments disclosed herein. Large language models are a type of deep learning model that use large amounts of training data to analyze and understand natural language. The large language models may be trained with queries, statuses, recommendation, alerts, messages, insights, actions, etc. The artificial intelligence vision system 106 may execute the synchronization manager 107 to perform the synchronization techniques disclosed herein.

The artificial intelligence vision system 106 may execute other types of artificial intelligence, such as expert systems, deep learning models, neural networks, and the like. The cloud-based computing system 116 may also include the database 129 that stores data, knowledge, and data structures used to perform various embodiments. For example, the database 129 may store a history of information related to users, assets, workflows, physical objects, physical environments, interactions, inventories, supply chains, object models, transcripts, knowledge graphs, templates, user profiles, user preferences, usage histories, and the like. In some embodiments, the database 129 may be hosted on one or more of the servers 128.

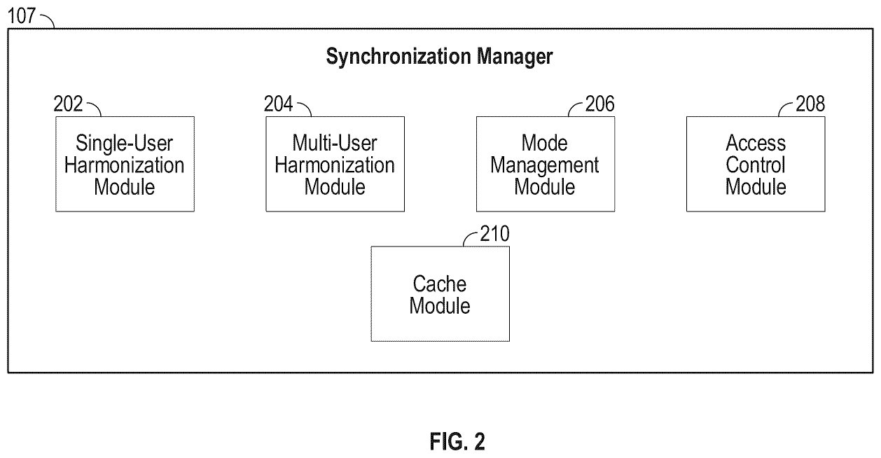

FIG. 2 depicts a diagram 200 of a synchronization manager 107 of an artificial intelligence vision system 106 according to some embodiments. In the example, the synchronization manager 107 includes a single-user harmonization module 202, a multi-user harmonization module 202, a mode management module 206, an access control module 208, and a cache module 210.

The single-user harmonization module 202 may function to harmonize augmented reality images presented in a user's (e.g., follower user, apprentice user, leader user, master user, etc.) private workspace. More specifically, portions (e.g., objects) of an augmented reality display may be designated as a synchronized element. For example, an augmented reality representation of a globe may be designated as a synchronized element so that the augmented reality representation is synchronized (e.g., in real-time) across different screens or display areas of the augmented reality display (e.g., a globe in a second augmented reality headset is synchronized in real-time with the globe in a first augmented reality headset).

The multi-user harmonization module 204 may function to harmonize augmented reality images across different computing devices 12, 14. In some embodiments, each user may have their own private virtual workspace, and augmented reality images (e.g., rendered from 3D models, data streams, etc.) may be independently rendered in each private virtual workspace. Accordingly, even in a collaborative environment, an augmented reality object (e.g., a vehicle) that is viewed by a user is rendered specifically for that user, as opposed to all users merely viewing the same augmented reality object. This can allow, for example, different users to have different views of the same augmented reality object. For example, a mechanical engineer user may be presented with a different view or information of an augmented reality object than an electrical engineer user.

The mode management module 206 may function to create, read, update, delete (CRUD) various modes (or, states) of an augmented reality environment. The mode management module 206 can switch modes (e.g., in response to user inputs), save states, load states, and the like. In one example, the mode management module 206 can save a state of an enterprise augmented reality session (e.g., a meeting with multiple users viewing multi-dimensional virtual environments) which can then be loaded at a subsequent time. Similarly, the mode management module 206 can load aspects of a prior enterprise augmented reality session into a current enterprise augmented reality session. For example, a user meeting with their supervisor may load documents presented in a prior augmented reality session for view by the supervisor in the current session without the supervisor having to be a part of the initial session.

The access control module 208 may function to provide access control functionality in an enterprise augmented reality environment. The access control may be role based. For example, the access control module 208 may determine whether a particular user has permission to view information before that information is transmitted the user's device and/or displayed on the user's device. In one example, there may be one leader and five followers. The leader may have full access, but some of the followers may have more limited access to viewing a multi-dimensional virtual environment including one or more virtual objects and/or visual elements. The access control module 208 can ensure that the followers are not presented with sensitive information that they are not allowed to access.

The access control module 208 may also provide custom views based on a user's role and permissions. For example, a law enforcement supervisor might see full details on a suspect including protected personal data, but when the supervisor shares this view with another officer, the protected fields can be redacted and not displayed to the officer as defined by law and access control parameters set in the application.

The cache module 210 may store interactions with and between virtual objects, synchronized elements, and/or visual elements presented via a multi-dimensional virtual environment. The cache module 210 may store states of each element, component, virtual element, visual element, synchronized element, etc. to enable numerous computing devices 12-N and 14-N to synchronize shared multi-dimensional virtual environments in real-time and/or near real-time.

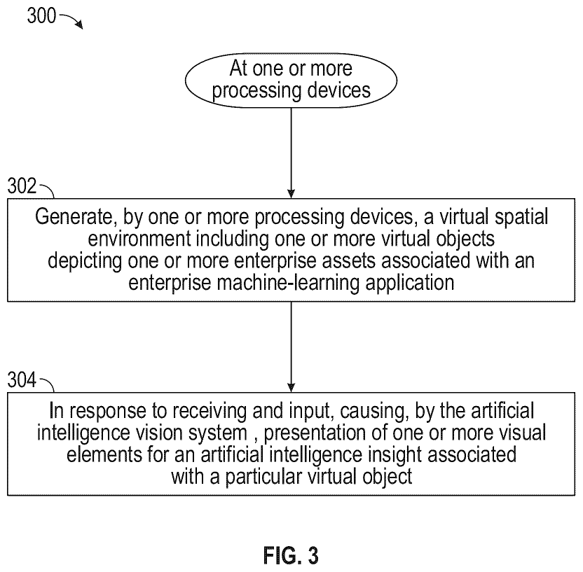

FIG. 3 illustrates an example of a method 300 for using an artificial intelligence vision system 106 to generate a multi-dimensional virtual environment including one or more enterprise insights according to certain embodiments of this disclosure. The method 300 may be performed by processing logic that may include hardware (circuitry, dedicated logic, etc.), software, or a combination of both. The method 300 and/or each of their individual functions, subroutines, or operations may be performed by one or more processing devices of a computing device (e.g., any component (artificial intelligence vision system 106, server 128, synchronization manager 107, training engine 152, models 154, etc.) of cloud-based computing system 116 and/or computing devices 12 and/or 14 of FIG. 1) implementing the method 300. The method 300 may be implemented as computer instructions stored on a memory device and executable by the one or more processing devices. In certain implementations, the method 300 may be performed by a single processing thread. Alternatively, the method 300 may be performed by two or more processing threads, each thread implementing one or more individual functions, routines, subroutines, or operations of the methods. In some embodiments, one or more accelerators may be used to increase the performance of a processing device by offloading various functions, routines, subroutines, or operations from the processing device.

For simplicity of explanation, the method 300 is depicted and described as a series of operations. However, operations in accordance with this disclosure can occur in various orders or concurrently, and with other operations not presented and described herein. For example, the operations depicted in the method 300 may occur in combination with any other operation of any other method disclosed herein. Furthermore, not all illustrated operations may be required to implement the method 300 in accordance with the disclosed subject matter. In addition, those skilled in the art will understand and appreciate that the method 300 could alternatively be represented as a series of interrelated states via a state diagram or events.

In some embodiments, one or more models (e.g., machine learning models, neural networks, expert systems, etc.) may be generated and trained by the artificial intelligence vision system 106 and/or the training engine 152 to perform one or more of the operations of the methods described herein. For example, to perform the one or more operations, the processing device May execute the one or more models. In some embodiments, the one or more models may be iteratively retrained to select different features capable of enabling optimization of output. The features that may be modified may include a number of nodes included in each layer of the models, an objective function executed at each node, a number of layers, various weights associated with outputs of each node, and the like.

At block 302, the one or more processing devices executing an artificial intelligence vision system 106 may render a multi-dimensional virtual environment including one or more virtual objects representing one or more physical objects. The multi-dimensional virtual environment may be rendered based on a physical environment including the one or more physical objects. The multi-dimensional virtual environment may be rendered based on a digital twin of a physical environment representing at least one of a current, historical, and projected state of one or more physical objects. For example, a turbine virtual object in a multi-dimensional virtual environment may represent a turbine physical object in a physical environment. In some embodiments, the virtual environment may be multi-dimensional including two dimensions, three dimensions, four dimensions, etc. The one or more physical environment may include one or more buildings, settings, systems, controllers, vehicles, rooms, robots, machines, or some combination thereof.

At block 304, the one or more processing devices may generate, using one or more computer-implemented models 154 of the artificial intelligence vision system 106, one or more enterprise insights associated with at least the one or more virtual objects. The one or more enterprise insights may be generated via the one or more computer-implemented models 154, such as machine learning models, neural networks, expert systems, and the like. In some embodiments, the one or more computer-implemented models 154 may be trained to generate the one or more enterprise insights based on one or more enterprise workflows, preferences of users, historical usage patterns of users, or some combination thereof.

In some embodiments, the one or more enterprise insights may pertain to statuses, alerts, messages, locations, parameters, values, vehicles, buildings, people, robots, machines, buildings, or some combination thereof. For example, the enterprise insights may be generated by the computer-implemented models 154 performing predictive maintenance and providing an alert when a certain sensor measurement exceeds a threshold.

At block 306, the one or more processing devices may cause, using the artificial intelligence vision system 106, presentation of one or more visual elements in conjunction with the one or more virtual objects. The one or more visual elements may represent the one or more enterprise insights. The visual elements may be generated via the one or more computer-implemented models 154. In some embodiments, the one or more computer-implemented models 154 may be trained to generate the one or more visual elements based on one or more enterprise workflows, preferences of users, historical usage patterns of users, or some combination thereof.

In some embodiments, one or more access control rules for a user may be used to determine which virtual objects the user may access, view, modify, create, delete, etc. The access control rules may be based on roles associated with the users. For example, an electrical engineer may be assigned a first set of access control rules that enables the electrical engineer to view/access virtual objects that may be used to interact with one or more electrical components of a machine, and a mechanical engineer may be assigned a second set of access control rules that enables the mechanical engineer to view/access virtual objects that may be used to interact with one or more mechanical components of the machine. The access control rules for the roles (e.g., electrical engineer and the mechanical engineer) may be different such that each role has access to at least some virtual objects that the other role cannot access. Accordingly, in some embodiments, the one or more virtual objects rendered on a user interface are based on one or more access control rules for a user. The one or more processing devices may synchronize the one or more virtual objects between a set of display areas associated with a set of applications concurrently presented in a user interface on a display of a computing device.

The one or more processing devices may receive, from one or more input devices, input from a user. The input may pertain to the one or more virtual objects. In some embodiments, the input may include a query (e.g., a natural language query posed as a question) and the one or more processing devices may, based on the query, identify, using one or more large language models, at least a subset of the one or more enterprise insights. In some embodiments, the one or more processing devices may render the multi-dimensional virtual environment including at least a subset of the one or more virtual objects associated with the subset of the one or more enterprise insights. In some embodiments, the input may include one or more limb gestures (e.g., arm wave), appendage gestures (e.g., finger movement), eye gaze, eye movement, head movement, voice, touch, noise, or some combination thereof. The one or more processing devices may synchronize, using the artificial intelligence vision system 106 executing the synchronization manager 107, the one or more visual elements and/or the virtual objects within the multi-dimensional virtual environment presented via a set of computing devices associated with a set of users. The one or more processing devices may overlay the multi-dimensional virtual environment at least partially on a physical environment visible through one or more computing devices used by one or more users. For example, one or more virtual objects may be overlaid on physical objects in a user interface presented via a display of a computing device. The computing device may include a virtual retinal display that projects images onto a retina of a user. In some embodiments, the computing device may be a virtual reality and/or augmented reality headset worn by the user. The one or more processing devices may receive, via the one or more input devices, one or more selections of at least one of the one or more visual elements or the one or more virtual objects. In some embodiments, the one or more processing devices may transmit, to one or more processing devices of the one or more physical objects associated with the selected visual elements or the selected virtual objects, one or more control instructions to cause one or more modifications to operation of the one or more physical objects.

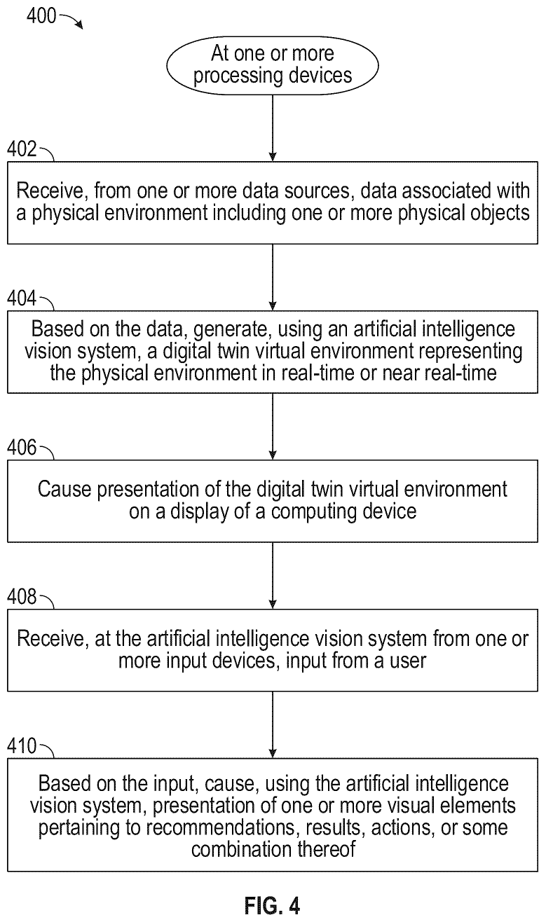

FIG. 4 illustrates an example of a method 400 for using an artificial intelligence vision system 106 to generate a digital twin virtual environment of a physical environment according to certain embodiments of this disclosure. The method 400 may be performed by processing logic that may include hardware (circuitry, dedicated logic, etc.), software, or a combination of both. The method 400 and/or each of their individual functions, subroutines, or operations may be performed by one or more processing devices of a computing device (e.g., any component (artificial intelligence vision system 106, server 128, synchronization manager 107, training engine 152, models 154, etc.) of cloud-based computing system 116 and/or computing devices 12 and/or 14 of FIG. 1) implementing the method 400. The method 400 may be implemented as computer instructions stored on a memory device and executable by the one or more processing devices. In certain implementations, the method 400 may be performed by a single processing thread. Alternatively, the method 400 may be performed by two or more processing threads, each thread implementing one or more individual functions, routines, subroutines, or operations of the methods. In some embodiments, one or more accelerators may be used to increase the performance of a processing device by offloading various functions, routines, subroutines, or operations from the processing device.

For simplicity of explanation, the method 400 is depicted and described as a series of operations. However, operations in accordance with this disclosure can occur in various orders or concurrently, and with other operations not presented and described herein. For example, the operations depicted in the method 400 may occur in combination with any other operation of any other method disclosed herein. Furthermore, not all illustrated operations may be required to implement the method 400 in accordance with the disclosed subject matter. In addition, those skilled in the art will understand and appreciate that the method 400 could alternatively be represented as a series of interrelated states via a state diagram or events.

In some embodiments, one or more models (e.g., machine learning models, neural networks, expert systems, etc.) may be generated and trained by the artificial intelligence vision system 106 and/or the training engine 152 to perform one or more of the operations of the methods described herein. For example, to perform the one or more operations, the processing device may execute the one or more models. In some embodiments, the one or more models may be iteratively retrained to select different features capable of enabling optimization of output. The features that may be modified may include a number of nodes included in each layer of the models, an objective function executed at each node, a number of layers, various weights associated with outputs of each node, and the like.

At block 402, the one or more processing devices may receive, from one or more data sources, data associated with a physical environment including one or more physical objects. In some embodiments, The data may be a system status or virtual measurements or sensor measurements, or some combination thereof. At least a subset of the one or more data sources may be disposed at the physical environment. In some embodiments, the one or more data sources may include one or more sensors (e.g., current sensor, temperature sensor, voltage sensor, vibration sensor, accelerometer, oxygen sensor, carbon monoxide sensor, velocity sensor, speed sensor, motion sensor, etc.), cameras (e.g., still image camera, video camera, etc.), microphones, databases, application programming interfaces, or some combination thereof.

At block 404, based on the data, the one or more processing devices may generate, by executing an artificial intelligence vision system 106, a spatial environment (e.g., a digital twin virtual environment representing the physical environment) can include real-time or near real-time. The virtual spatial environment may include one or more virtual objects representing the one or more physical objects. In some embodiments, the one or more virtual objects may be associated with a current, historical, and/or projected state of a respective physical object.

In some embodiments, the one or more processing devices may synchronize the one or more virtual objects between a set of display areas associated with a set of applications (e.g., enterprise software applications) concurrently presented in a user interface on a display of a computing device. At block 406, the one or more processing devices may receive, at the artificial intelligence vision system 106 from one or more input devices, input from a user. The input may pertain to at least one of the one or more virtual objects. The one or more input devices may include a mouse, a keyboard, a touchscreen, a touchpad, a camera, a microphone, or some combination thereof.

At block 408, based on the input, the one or more processing devices may cause, by executing the artificial intelligence vision system 106, presentation of one or more visual elements pertaining to recommendations, results, actions, or some combination thereof on a user interface of a computing device. In some embodiments, the computing device may include an augmented reality device, a virtual reality device, a smartphone, a laptop, a tablet, goggles, a monocle, glasses, headset, or the like. In some embodiments, the one or more visual elements may enable viewing a chronological order of states associated with a respective physical object.

In some embodiments, the one or more processing devices may establish, via the artificial intelligence vision system 106, one or more communication connections with the one or more physical objects. For example, a wireless and/or wired connection may be established between a network interface card and/or controller of the one or more physical object and the artificial intelligence vision system executing via the one or more processing devices. In some embodiments, based on the input pertaining to the at least one of the one or more virtual objects, the one or more processing devices may transmit, via the one or more communication connections, one or more control instructions to control operation of the one or more physical objects.

The artificial intelligence vision system 106 may be trained (e.g., via the training engine 152) to generate one or more enterprise insights based on one or more enterprise workflows, preferences of users, historical usage patterns of users, or some combination thereof. In some embodiments, the one or more processing devices may automatically cause presentation of the one or more enterprise insights in the digital twin virtual environment depicted in a user interface on a display of a computing device. The one or more enterprise insights may be associated with the one or more virtual objects and/or visual elements presented in the digital twin virtual environment. The one or more processing devices may synchronize, using the synchronization manager 107 executed by the artificial intelligence vision system 106, the one or more visual elements within the digital twin virtual environment concurrently presented via a set of computing devices associated with a set of users.

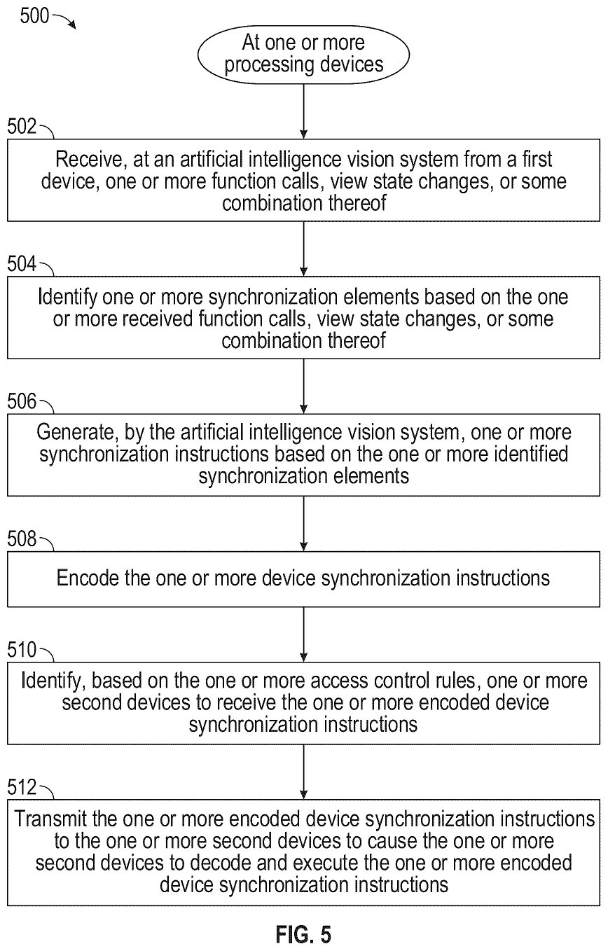

FIG. 5 illustrates an example of a method 500 for using an artificial intelligence vision system 106 to execute a synchronization manager 107 according to certain embodiments of this disclosure. The method 500 may be performed by processing logic that may include hardware (circuitry, dedicated logic, etc.), software, or a combination of both. The method 500 and/or each of their individual functions, subroutines, or operations may be performed by one or more processing devices of a computing device (e.g., any component (artificial intelligence vision system 106, server 128, synchronization manager 107, training engine 152, models 154, etc.) of cloud-based computing system 116 and/or computing devices 12 and/or 14 of FIG. 1) implementing the method 500. The method 500 may be implemented as computer instructions stored on a memory device and executable by the one or more processing devices. In certain implementations, the method 500 may be performed by a single processing thread. Alternatively, the method 500 may be performed by two or more processing threads, each thread implementing one or more individual functions, routines, subroutines, or operations of the methods. In some embodiments, one or more accelerators may be used to increase the performance of a processing device by offloading various functions, routines, subroutines, or operations from the processing device.

For simplicity of explanation, the method 500 is depicted and described as a series of operations. However, operations in accordance with this disclosure can occur in various orders or concurrently, and with other operations not presented and described herein. For example, the operations depicted in the method 500 may occur in combination with any other operation of any other method disclosed herein. Furthermore, not all illustrated operations may be required to implement the method 500 in accordance with the disclosed subject matter. In addition, those skilled in the art will understand and appreciate that the method 500 could alternatively be represented as a series of interrelated states via a state diagram or events.

In some embodiments, one or more models (e.g., machine learning models, neural networks, expert systems, etc.) may be generated and trained by the artificial intelligence vision system 106 and/or the training engine 152 to perform one or more of the operations of the methods described herein. For example, to perform the one or more operations, the processing device may execute the one or more models. In some embodiments, the one or more models may be iteratively retrained to select different features capable of enabling optimization of output. The features that may be modified may include a number of nodes included in each layer of the models, an objective function executed at each node, a number of layers, various weights associated with outputs of each node, and the like.

At block 502, the one or more processing devices may receive, at an artificial intelligence vision system 106 from a first computing device 12, one or more function calls, view state changes, redux actions, or some combination thereof. For example, an enterprise application may be executing on the first computing device 12 and a user may use an input device to enter input that causes one or more function calls, view state changes, redux actions, or some combination thereof to be transmitted to the artificial intelligence vision system 106. The enterprise application may use a user interface 160 to present a subsystem (e.g., compressor) at an asset (e.g., factory) in a multi-dimensional virtual environment, for example. The user may use the input device to interact with the subsystem that causes the one or more function calls, view state changes, redux actions, or some combination thereof to be transmitted to the artificial intelligence vision system 106.

At block 504, the one or more processing devices may identify one or more synchronization elements based on the one or more received function calls, view state changes, redux actions, or some combination thereof. In some embodiments, the one or more processing devices may render a multi-dimensional virtual environment including the one or more synchronization elements. In some embodiments, at least some of the one or more synchronization elements may represent physical elements in a physical environment. For example, a virtual object of a compressor may represent an actual compressor in an actual factory. The one or more received function calls, view state changes, and/or redux actions may be associated with the virtual object. The artificial intelligence vision system 106 may identify the virtual object as a synchronization element. In some embodiments, the synchronization element may be synchronized between enterprise applications executing via the first computing device 12 and/or between numerous computing devices executing a shared multi-dimensional virtual environment.

In some embodiments, the one or more synchronization elements may be associated with a chronological order of historical, current, and projected states. The one or more processing devices may present the chronological order in a multi-dimensional virtual environment. For example, a graphical element, such as a slider, may be used to present the chronological order in the multi-dimensional virtual environment. The user may use an input device to interact with the first computing device 12 to scroll between different times to view past, current, and/or projected states associated with the synchronization elements in the multi-dimensional virtual environment.

At block 506, the one or more processing devices may generate, by executing the artificial intelligence vision system 106, one or more device synchronization instructions based on the one or more identified synchronization elements. For example, if a function call for modifying a viewpoint of the subsystem to an exploded view represented by the synchronization element is received from the first computing device 12, then the artificial intelligence engine may generate one or more device synchronization instructions that cause the synchronization element associated with the subsystem to modify their viewpoints to exploded views by other computing devices 14 sharing the multi-dimensional virtual environment, accordingly.

At block 508, the one or more processing devices may encode the one or more device synchronization instructions. For example, any suitable encoding technique may be used to convert the one or more device synchronization instructions into a specific format for transmission, storage, and/or execution by one or more processing devices. The one or more device synchronization instructions may be encoded to enable device-agnostic interaction with the artificial intelligence vision system 106.

At block 510, the one or more processing devices may identify, based on one or more access control rules, one or more second computing devices 14 to receive the one or more encoded device synchronization instructions. For example, the one or more access control rules may be role-based and specify that certain roles are granted certain permissions to interact with certain visual elements, virtual objects, assets, etc. within multi-dimensional virtual environments. The roles may be assigned to each user and stored in the database 129. The roles may include different titles such as manager, engineer (e.g., electrical, software, mechanical, etc.), accountant, assistant, etc. The access control rules may specify that one role is permitted to create, read, update, and delete a first subset of data and a second role is permitted to create, read, update, and delete a second subset of data (the first subset of data and the second subset of data may be completely different, may partially overlap, or may be the same).

At block 512, the one or more processing devices may transmit the one or more encoded device synchronization instructions to the one or more second computing devices 14 to cause the one or more second computing devices 14 to decode and execute the one or more encoded device synchronization instructions. In some embodiments, execution of the one or more decoded device synchronization instructions may synchronize controls, actions, views, accesses, rights, etc. of the one or more synchronization elements concurrently on the first computing device 12 and the one or more second computing devices 14.

In some embodiments, the one or more processing devices may generate, by executing the artificial intelligence vision system 106, one or more application synchronization instructions based on the one or more identified synchronization elements. In some embodiments, the one or more processing devices of the first computing device 12 may execute the application synchronization instructions to cause the one or more synchronization elements to be controlled concurrently in one or more display areas associated with one or more enterprise applications presented in a user interface on a display of the first computing device 12.

In some embodiments, the one or more processing devices may generate, by executing the artificial intelligence vision system 106, one or more enterprise insights. The enterprise insights may be generated by one or more computer-implemented models 154. The one or more processing devices may cause presentation of the one or more enterprise insights associated with the one or more synchronization elements. In some embodiments, the one or more processing devices may receive, via one or more input devices, inputs pertaining to the one or more enterprise insights. In some embodiments, based on the inputs, the one or more processing devices may perform the one or more actions.

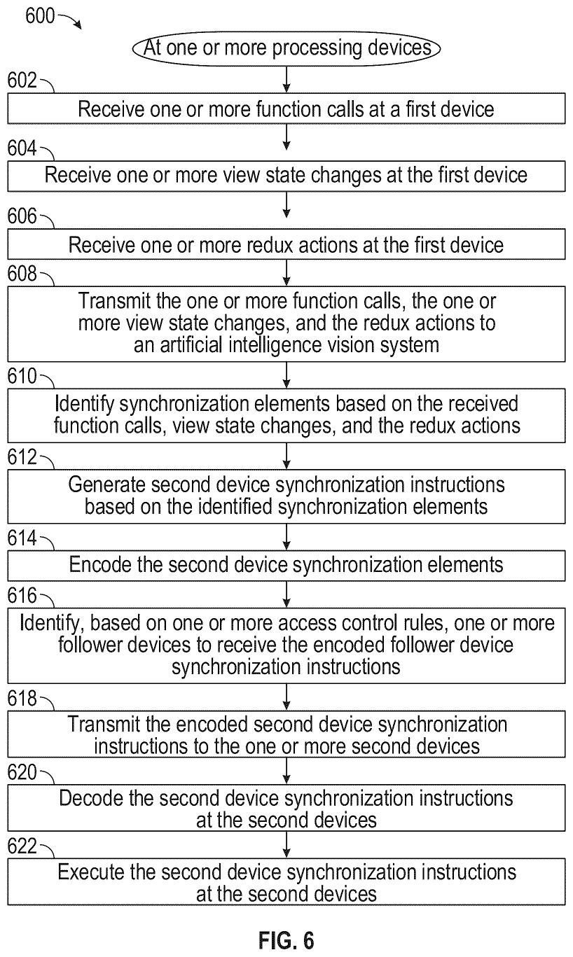

FIG. 6 illustrates an example of a method 600 for numerous computing devices interacting with an artificial intelligence vision system 106 according to certain embodiments of this disclosure. The method 600 may be performed by processing logic that may include hardware (circuitry, dedicated logic, etc.), software, or a combination of both. The method 600 and/or each of their individual functions, subroutines, or operations may be performed by one or more processing devices of a computing device (e.g., any component (artificial intelligence vision system 106, server 128, synchronization manager 107, training engine 152, models 154, etc.) of cloud-based computing system 116 and/or computing devices 12 and/or 14 of FIG. 1) implementing the method 600. The method 600 may be implemented as computer instructions stored on a memory device and executable by the one or more processing devices. In certain implementations, the method 600 may be performed by a single processing thread. Alternatively, the method 600 may be performed by two or more processing threads, each thread implementing one or more individual functions, routines, subroutines, or operations of the methods. In some embodiments, one or more accelerators may be used to increase the performance of a processing device by offloading various functions, routines, subroutines, or operations from the processing device.

For simplicity of explanation, the method 600 is depicted and described as a series of operations. However, operations in accordance with this disclosure can occur in various orders or concurrently, and with other operations not presented and described herein. For example, the operations depicted in the method 600 may occur in combination with any other operation of any other method disclosed herein. Furthermore, not all illustrated operations may be required to implement the method 600 in accordance with the disclosed subject matter. In addition, those skilled in the art will understand and appreciate that the method 600 could alternatively be represented as a series of interrelated states via a state diagram or events.

In some embodiments, one or more models (e.g., machine learning models, neural networks, expert systems, etc.) may be generated and trained by the artificial intelligence vision system 106 and/or the training engine 152 to perform one or more of the operations of the methods described herein. For example, to perform the one or more operations, the processing device may execute the one or more models. In some embodiments, the one or more models may be iteratively retrained to select different features capable of enabling optimization of output. The features that may be modified may include a number of nodes included in each layer of the models, an objective function executed at each node, a number of layers, various weights associated with outputs of each node, and the like.

At block 602, a first computing device 12 (e.g., leader device, master device, teacher device, etc.) receives one or more function calls. In some embodiments, a first computing device controller 103 receives the one or more function calls. For example, an enterprise application may be executing on the first computing device 12 and a user may use an input device to enter input that causes the one or more function calls to be transmitted to the artificial intelligence vision system 106. The enterprise application may use a user interface 160 to present a subsystem (e.g., compressor) at an asset (e.g., factory) in a multi-dimensional virtual environment, for example. The user may use the input device to interact with the subsystem that causes the one or more function calls to be transmitted to the artificial intelligence vision system 106.

At block 604, the first computing device 12 receives one or more view state changes. In some embodiments, the first computing device controller 103 receives the one or more view state changes. For example, the enterprise application may be executing on the first computing device 12 and the user may use the input device to enter input that causes the one or more view state changes to be transmitted to the artificial intelligence vision system 106. The enterprise application may use the user interface 160 to present the subsystem (e.g., compressor) at the asset (e.g., factory) in the multi-dimensional virtual environment, for example. The user may use the input device to interact with the subsystem that causes the one or more view state changes to be transmitted to the artificial intelligence vision system 106.

At block 606, the first computing device 12 receives one or more redux actions. In some embodiments, the first computing device controller 103 receives the one or more redux actions. For example, the enterprise application may be executing on the first computing device 12 and the user may use the input device to enter input that causes the one or more redux actions to be transmitted to the artificial intelligence vision system 106. The enterprise application may use the user interface 160 to present the subsystem (e.g., compressor) at the asset (e.g., factory) in the multi-dimensional virtual environment, for example. The user may use the input device to interact with the subsystem that causes the one or more redux actions to be transmitted to the artificial intelligence vision system 106.

At block 608, the first computing device 12 transmits the one or more function calls, the one or more view state changes, and the one or more redux actions to an artificial intelligence vision system (e.g., artificial intelligence vision system 106). In some embodiments, the first computing device controller 103 transmits the one or more function calls, the one or more view state changes, and the one or more redux actions to the artificial intelligence vision system over a communications network 20 (e.g., WAN, LAN, Internet, Wi-Fi network, etc.).

At block 610, the artificial intelligence vision system 106 identifies synchronization elements based on the received function calls, view state changes, and the redux actions. In some embodiments, a synchronization manager 107 identifies the synchronization elements. In some embodiments, the one or more processing devices may render a multi-dimensional virtual environment including the one or more synchronization elements. In some embodiments, at least some of the one or more synchronization elements may represent physical elements in a physical environment. For example, a virtual object of a compressor may represent an actual compressor in an actual factory. The one or more received function calls, view state changes, and/or redux actions may be associated with the virtual object. The artificial intelligence vision system 106 may identify the virtual object as a synchronization element. In some embodiments, the synchronization element may be synchronized between enterprise applications executing via the first computing device 12 and/or between numerous computing devices 14 executing a shared multi-dimensional virtual environment.

At block 612, the artificial intelligence vision system 106 generates second computing device synchronization instructions based on the identified synchronization elements. In some embodiments, the synchronization manager 107 generates the second computing device instructions. For example, if a function call for modifying a viewpoint of the subsystem to an exploded view represented by the synchronization element is received from the first computing device 12, then the artificial intelligence engine may generate one or more device synchronization instructions that cause the synchronization element associated with the subsystem to modify their viewpoints to exploded views by other computing devices sharing the multi-dimensional virtual environment, accordingly.

At block 614, the artificial intelligence vision system 106 encodes the second computing device synchronization instructions. In some embodiments, the synchronization manager 107 encodes the second computing device instructions. For example, any suitable encoding technique may be used to convert the one or more device synchronization instructions into a specific format for transmission, storage, and/or execution by one or more processing devices. The one or more device synchronization instructions may be encoded to enable device-agnostic interaction with the artificial intelligence vision system 106.

At block 616, the artificial intelligence vision system 106 identifies, based on one or more access control rules, one or more second computing devices 14 to receive the encoded follower device synchronization instructions. In some embodiments, the synchronization manager 107 identifies the one or more second computing devices 14 based on the one or more access control rules. For example, the one or more access control rules may be role-based and specify that certain roles are granted certain permissions to interact with certain visual elements, virtual objects, assets, etc. within multi-dimensional virtual environments. The roles may be assigned to each user and stored in the database 129. The roles may include different titles such as manager, engineer (e.g., electrical, software, mechanical, etc.), accountant, assistant, etc. The access control rules may specify that one role is permitted to create, read, update, and delete a first subset of data and a second role is permitted to create, read, update, and delete a second subset of data (the first subset of data and the second subset of data may be completely different, may partially overlap, or may be the same). The second computing devices 14 identified may be based on the roles associated with the users of those second computing devices 14.

At block 618, the artificial intelligence vision system 106 transmits the encoded second computing device synchronization instructions to one or more second computing devices 14. In some embodiments, the synchronization manager 107 transmits the encoded second computing device synchronization instructions to the one or more second computing devices 14. The artificial intelligence vision system 106 may transmit the encoded second computing device synchronization instructions via the network 20.

At block 620, the second computing devices 14 decode the second computing device synchronization instructions at the second computing devices 14. In some embodiments, second computing device controllers 105 decode the synchronization instructions. For example, any suitable decoding technique may be used to convert the second computing device synchronization instructions into a format executable by one or more enterprise applications and/or processing devices of the second computing devices 14.

At block 622, the second computing devices 14 execute the second computing device synchronization instructions at the second computing devices 14. In some embodiments, the second computing device controllers 105 execute the second computing device synchronization instructions. For example, if the second computing device synchronization instructions relate to modifying a viewpoint of a subsystem to an exploded view, executing the second computing device synchronization instructions may cause the second devices to show an exploded view of the subsystem on user interface 162 in the shared multi-dimensional virtual environment.

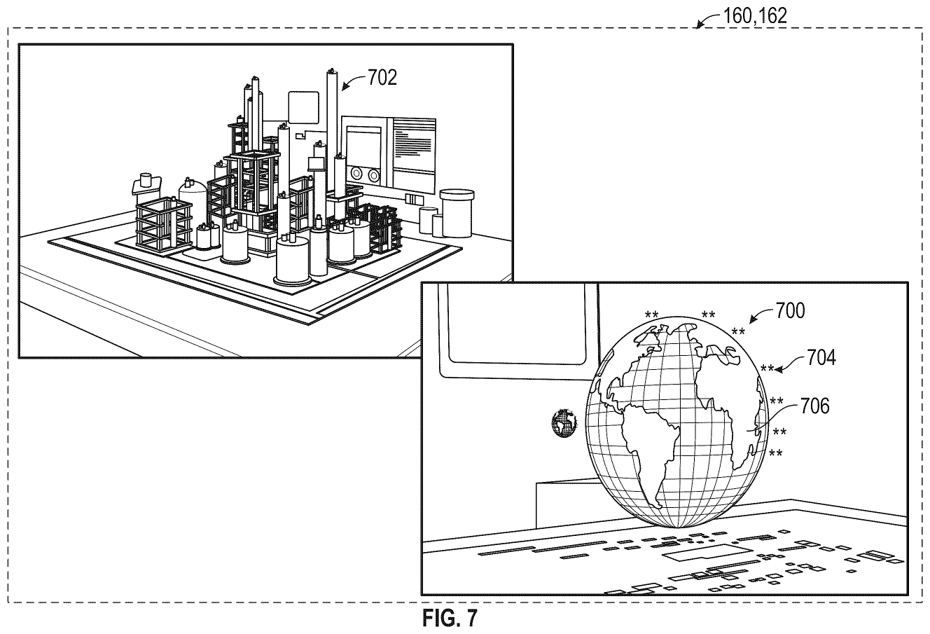

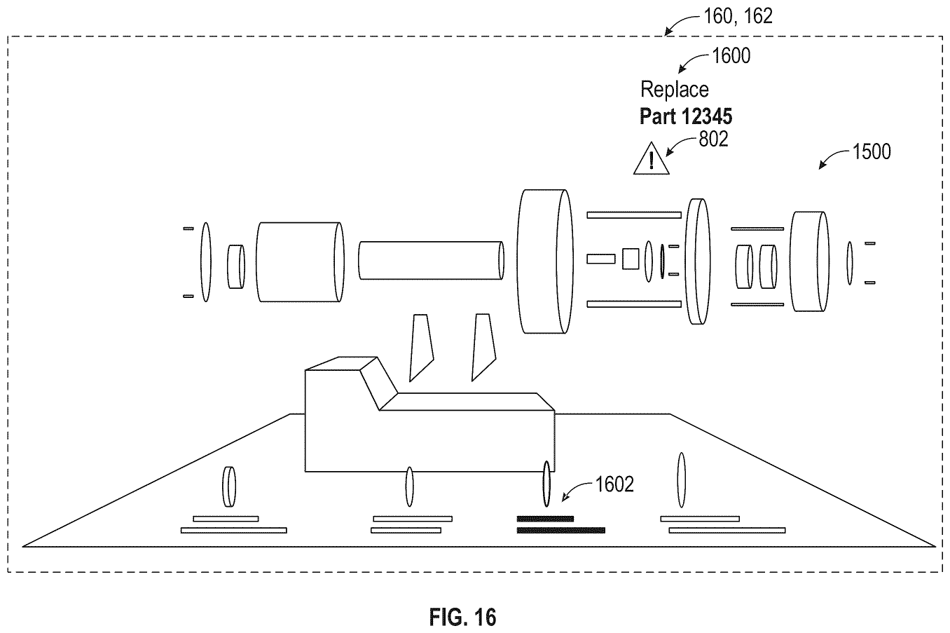

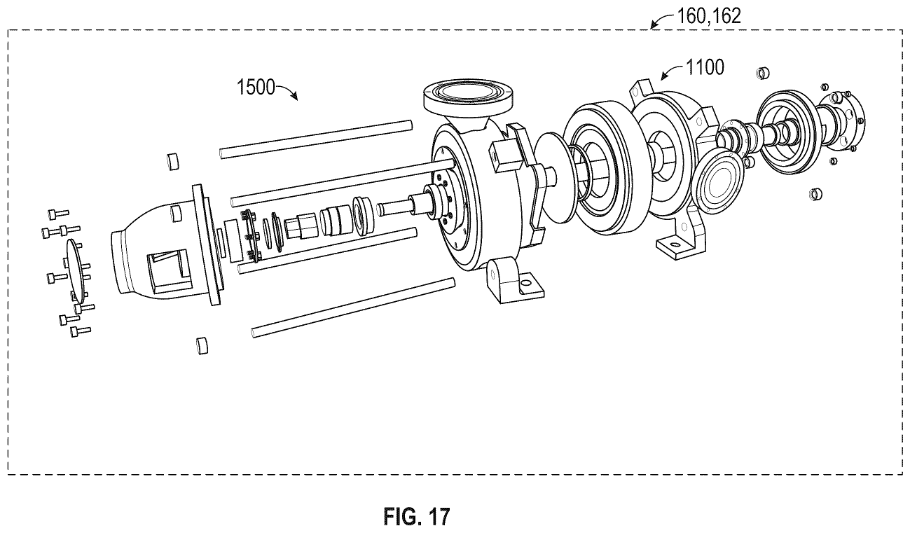

FIGS. 7-17 are now explained using a role of a reliability engineer as an example. In some embodiments, any graphical element presented via the user interfaces 160, 162, such as virtual objects and/or visual elements in a multi-dimensional virtual environment may be synchronized by the synchronization manager 107 depending on access control rules for each user using the computing devices 12-N and 14-N. Further, the synchronization manager 107 may synchronize the graphical elements (e.g., virtual objects, visual elements, augmented objects, mixed reality objects, etc.) between display areas associated with different enterprise applications presented in the user interfaces 160, 162. Thus, the graphical elements (e.g., virtual objects, visual elements, etc.) may be referred to as synchronized elements herein. The enterprise applications may be locally executed via the computing devices 12-N, 14-N and/or may be executed via the cloud-based computing system 116.

FIG. 7 illustrates another example user interface 160, 162 of an artificial intelligence vision system 106 depicting an overview of the asset 702 including visual elements and of the globe 700 including visual elements according to certain embodiments of this disclosure. In the depicted figure, the global 700 is represented as a globe virtual object and includes visual elements 704 and 706 associated with virtual assets. In some embodiments, the globe 700 and the asset 702 may be presented in different display areas provided by different enterprise applications executing on the computing device 12, 14 and/or executing on the cloud-based computing system 116.

As presented, the globe 700 and the asset 700 may be presented in a multi-dimensional (three dimensional) virtual environment as virtual objects overlaid on a real-world physical object, such as table in a physical room. The visual elements 704 and 706 displayed relative to the globe 700 may represent enterprise insights associated with one or more subsystems at one or more assets (e.g., 702) that are located at disparate geo-spatial locations around the world. In some instances, the visual elements may be generated by the one or more computer-implemented models 154 performing predictive maintenance. For example, one or more sensor measurements may cause the visual elements to be generated because the one or more sensor measurements exceed a threshold for a certain period of time.

The reliability engineer, in the ongoing example, may select visual element 704 associated with an enterprise insight generated for a subsystem at asset 702, which may be an oil refinery, a manufacturing plant, or any suitable asset (e.g., building, vehicle, machine, robot, etc.). Such techniques may enable the reliability engineer to monitor sensor readings from the asset 702 (while the reliability engineer is located disparately anywhere in the world) and proactively prevent issues before they cause unplanned downtime.

As depicted, the asset 702 may be presented in a display area in a different portion of the user interface 160, 162 concurrently as a display area presenting the globe 700. The display area presenting the asset 702 may include zoomed in detail pertaining to the physical objects at the physical environment of the asset 702 by showing the corresponding virtual objects in a virtual environment. In addition, visual elements such as alerts, notifications, results, recommendations, actions, and the like may be also presented with their respective virtual objects in the display area including the asset 702.

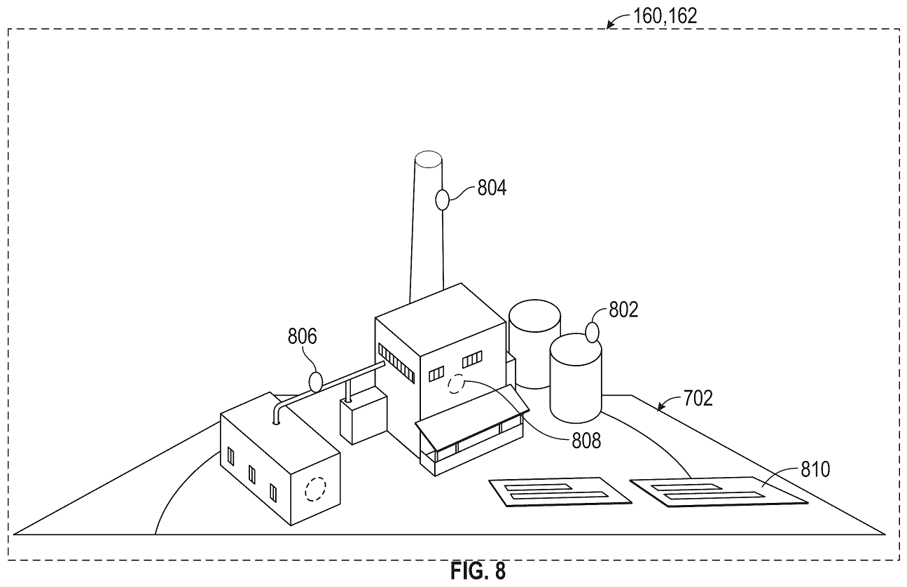

In the ongoing example, the reliability engineer may select the display area including the asset 702 by selecting the display area using an input device and/or peripheral (e.g., mouse, keyboard, camera, microphone, wand, wearable, BCI, lens, glasses, goggles, headset, etc.). The input selection may cause the user interface 160, 162 of computing devices 12, 14 to be presented in FIG. 8.

FIG. 8 illustrates an example user interface 160, 162 of an artificial intelligence vision system 106 depicting an overview of the asset 702 including visual elements 802, 804, and 806 according to certain embodiments of this disclosure. The user interface 160, 162 may be presented on the computing device 12, 14, respectively. The visual elements 802, 804, and 806 may represent the most critical alerts (e.g., the alerts associated with a highest risk score as compared to other risk scores) associated with one or more subsystems of the asset 702. For example, another visual element 808 may represent a subsystem that is causing the enterprise insight (e.g., alert 802) to be presented in the user interface 160, 162. In this example, the subsystem is a compressor. Another visual element 810 is depicted that may present information pertaining to the alert 802 and the virtual object representing the compressor at the physical environment. The information may include details pertaining to the compressor (e.g., manufacturer, sensors, location, etc.) and the alert (e.g., sensor measurement exceeding threshold, remaining useful life, etc.).

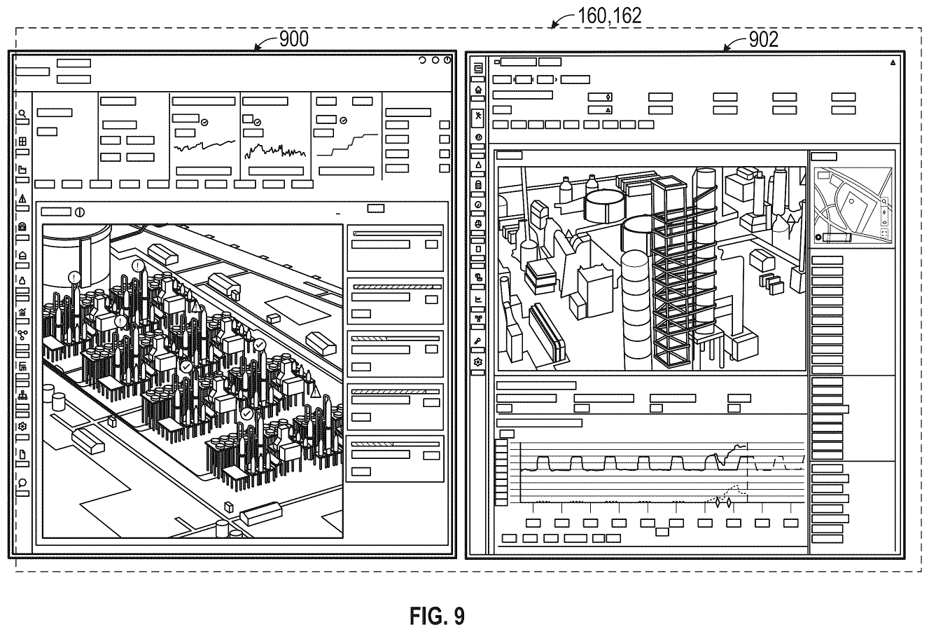

FIG. 9 illustrates another example user interface 160, 162 of an artificial intelligence vision system 106 depicting an overview of several assets 900 and 902 including visual elements according to certain embodiments of this disclosure. Similar to FIG. 8, visual elements may indicate the most critical alerts representing enterprise insights generated by the one or more computer-implemented models 154. In some embodiments, the assets 900 and 902 may be presented in different display areas associated with different AI applications executing via the computing devices 12, 14. In some embodiments, the assets 900 and 902 may be displayed on numerous user interfaces of computing devices 12, 14-N concurrently that are communicatively connected to the artificial intelligence vision system 106. Various graphical settings may be used to differentiate the presentation of the visual elements based on severity, priority, criticality, or the like. For example, the graphical settings may include highlighting, bolding, zooming, coloring, etc.

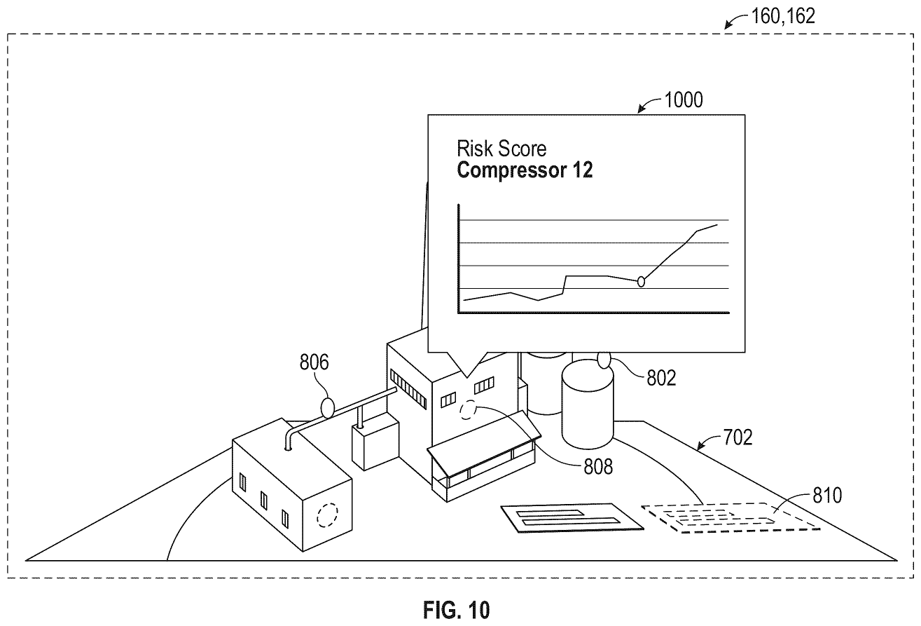

Returning to the ongoing example of the reliability engineer's use of the artificial intelligence vision system 106, the reliability engineer may select the visual element 810 presented in the user interface 160, 162 in FIG. 8. The input selection may cause a visual element 902 associated with the compressor to actuate (e.g., highlight) and a popup message 1000 to be presented via the user interface 160, 162, as shown in FIG. 10. The popup message 1000 may indicate a risk score for the compressor and show that the risk score has exceeded a threshold risk score and needs immediate attention. The reliability engineer may select a visual element to view additional details which may cause the user interface to drilldown into a facility including the compressor.

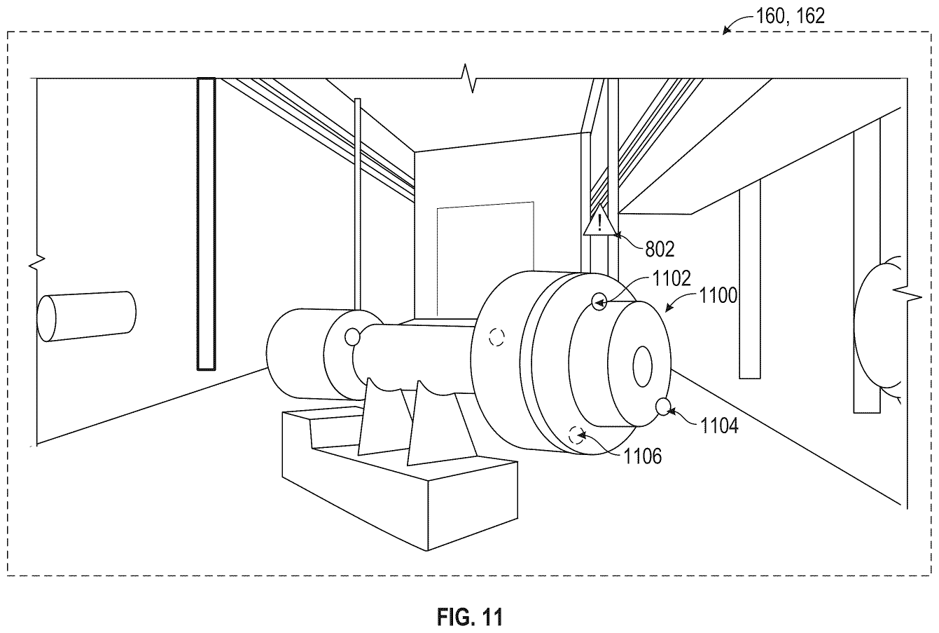

Based on the reliability engineer's selection, FIG. 11 illustrates another example user interface 160, 162 of an artificial intelligence vision system 106 depicting a detailed view of a subsystem (e.g., compressor 1100) of an asset 702 including visual elements 1102, 1104, and 1106 according to certain embodiments of this disclosure. The compressor 1100 may be represented as a virtual object that includes features, characteristics, and/or parameters that are physically accurate to the physical compressor located at the asset 702. Visual elements 1102, 1104, and 1106 may be associated with one or more data sources present in the physical environment, such sensors, cameras, microphones, etc. In the depicted example, visual element 1106 represented as a dashed circle may indicate that a risk score is below a threshold risk score by more than a certain desired amount. The visual element 1104 may be a filled in circle having a first color indicating the risk score for that portion of the compressor 1100 is approaching an undesired threshold risk score. The visual element 1102 may also be a filled in circle but having a second color indicating the risk score exceeds the threshold risk score, thereby causing the enterprise insight (e.g., alert 802) to be presented.

The user interface 160, 162 of the artificial intelligence vision system 106 may include a digital twin multi-dimensional virtual environment representing a real-world physical environment. For example, a schematic, map, diagram, or the like may be provided to the artificial intelligence vision system 106 to be used as the digital twin. In some embodiments, data sources located at, proximate, and/or remote from the physical environment may provide data that enables the artificial intelligence vision system 106 to generate, dynamically on the fly in real-time or near real-time, the digital twin multi-dimensional virtual environment.

In some embodiments, the compressor 1100 may include one or more controllers having processing devices and/or network interface cards and a communication connection (e.g., wireless, wired) may be established between the controllers and the artificial intelligence vision system 106. The artificial intelligence system 106 may enable a user (e.g., reliability engineer) to view the enterprise insights at any level (e.g., overview, drilled down level) and perform one or more actions (e.g., order a part, control operation of a subsystem, etc.) by transmitting one or more messages (e.g., control instructions) to the subsystem via the communication connection.

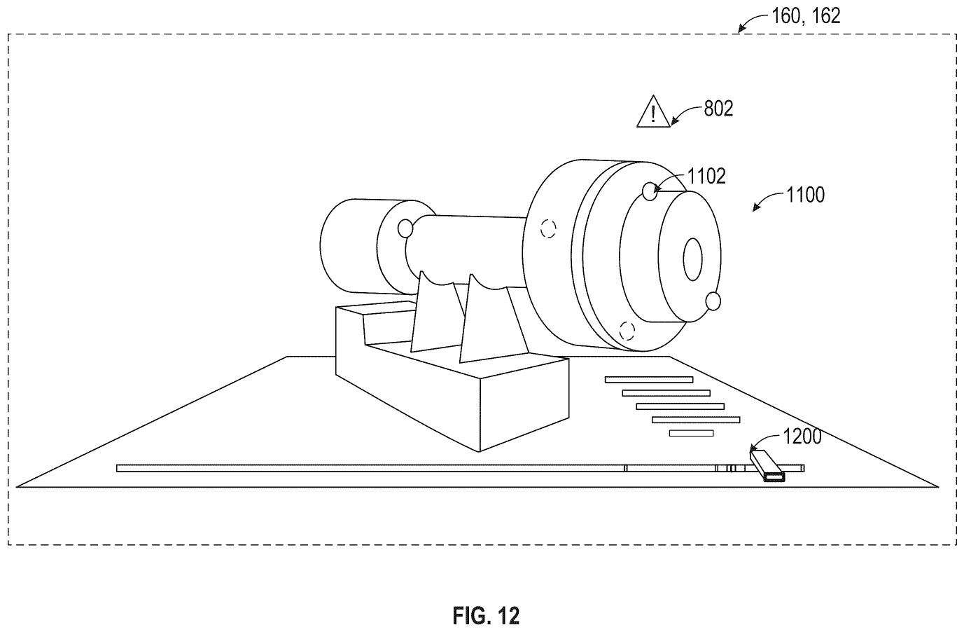

FIG. 12 illustrates another example user interface 160, 162 of an artificial intelligence vision system 106 depicting a detailed view of the subsystem including a chronological slider 1200 according to certain embodiments of this disclosure. As depicted, another visual element, chronological slider 1200, is depicted in the user interface 160, 162. The chronological slider 1200 may be actuated back and forth to show the current, past, and/or projected states of each portion of the compressor 1100. The visual elements 1102, 1104, and 1106 may change visual presentation based on the risk scores at any given time depending on where a bar of the chronological slider 1200 is moved to in a timespan. The chronological slider 1200 may include visual indications (e.g., red bars) indicating when predictive insights, such as alerts are present during certain times. Further, timestamps may be presented dynamically on the user interfaces 160, 162 as the chronological slider 1200 is actuated back and forth. Such techniques, may enable a user to view the progression of states of certain parts and portions of the compressor 1100, for example, over time. The user may view the sensor readings as they change over time for the compressor 1100 to understand how severe an issue is. The user may pinpoint the exact time at which action are to be taken, the exact time at which the risk score exceeded the threshold, the exact time operation of the compressor is to change, the exact time at which action was taken, among other things. Further, the past, current, and projected states, in conjunction with actions, recommendations, results, etc. may be fed back into the one or more computer-implemented models 154 to retrain the models 154 to generate more accurate enterprise insights. In some embodiments, the retraining of the computer-implemented models 154 may be performed at the cloud-based computing system 116 and one or more parameters of the retrained models 154 may be transmitted to the edge computing devices 12, 14 to be implemented

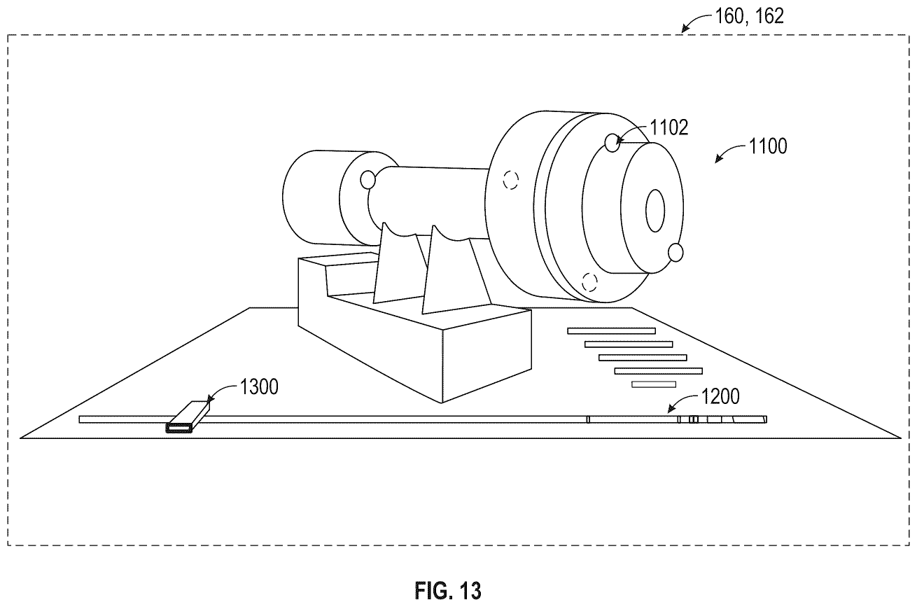

FIG. 13 illustrates another example user interface 160, 162 of an artificial intelligence vision system 106 depicting a detailed view of the subsystem (e.g., compressor 1100) including the chronological slider 1200 according to certain embodiments of this disclosure. As depicted, a bar 1300 the chronological slider 1200 has been actuated to an earlier timeframe than depicted in FIG. 12. The chronological slider 1200 in FIG. 13 has been moved to a timeframe when no visual indications of predictive insights are present on the chronological slider 1200. Accordingly, the predictive insight (e.g., alert 802) associated with the visual element 1102 is not presented for the compressor 1100 at the timeframe selected by the chronological slider 1200 in FIG. 13. Instead, the visual element 1102 is visually depicted using a bolded colored circle indicating the risk score has not exceeded a threshold risk score. The reliability engineer may replay the chronology of events starting at the selected time where sensor readings are in a normal range to better understand the progression of the sensor readings that caused the predictive insights (e.g., alert 802) to be generated. Various sensor readings (e.g., temperature, pressure, velocity, speed, current, voltage, etc.) may be presented at each time interval along the chronology and a description of events occurring at the time interval may be provided in the user interface 160, 162.

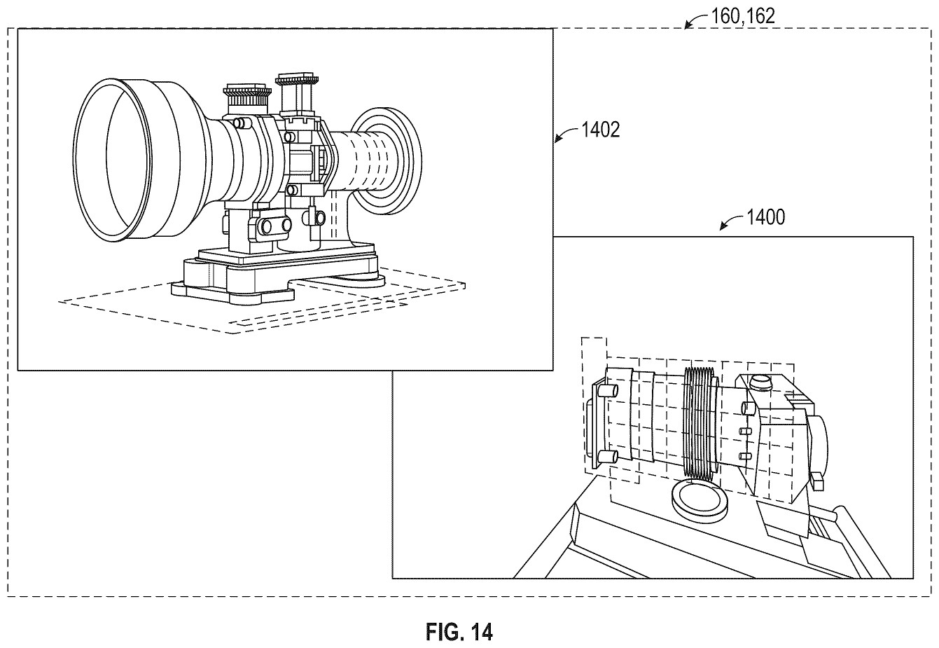

FIG. 14 illustrates another example user interface 160, 162 of an artificial intelligence vision system 106 depicting detailed views 1400 and 1402 of virtual objects representing the subsystem (e.g., compressor 1100) according to certain embodiments of this disclosure. The virtual objects may be overlaid on the physical object in the physical environment. Any component and/or part of the compressor 1100 may be controlled dynamically using the artificial intelligence vision system's 106 user interface 160, 162, which may be synchronized between numerous user's computing devices 12, 14. In some embodiments, the detailed views 1400 may be presented via different AI applications or the same AI application executing by the computing devices 12, 14. The AI application(s) may be communicatively connected to the artificial intelligence vision system 106 and receive the one or more virtual objects from the artificial intelligence vision system 106.

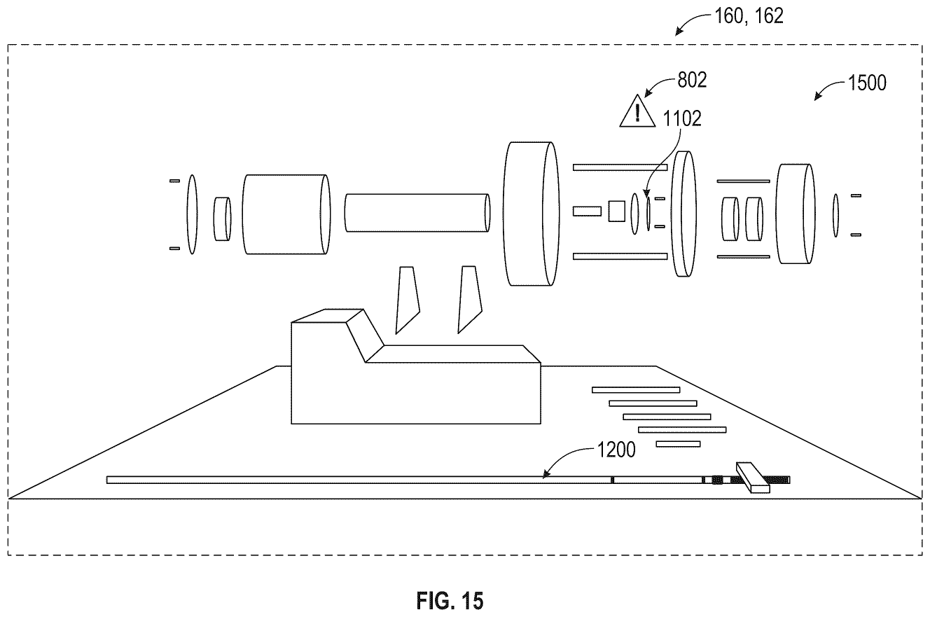

FIG. 15 illustrates another example user interface 160, 162 of an artificial intelligence vision system 106 depicting a multi-dimensional exploded detailed view 1500 of the subsystem (e.g., compressor 1100) including visual elements 1102, 802, and 1200 according to certain embodiments of this disclosure. As depicted, the chronological slider 1200 has been actuated to a timeframe when a predictive insight (e.g., alert 802) is generated and presented in the user interface 160, 162 (e.g., due to a risk score exceeding a threshold risk score associated with one or more sensor measurements). The alert 802 may be presented concurrently with the visual element 1102 associated with a specific part of the compressor 1100. The user interface 160, 162 in FIG. 15 depicts a realistic failure mode for the compressor 110 which is modeled in real-time or near real-time, which visualizes and informs the reliability engineer exactly which part of the compressor 1100 has failed. The virtual object representing the exploded detailed view 1500 of the real-world compressor 1100 may provide an immersive and interactive actionable 106 depicting another multi-dimensional exploded detailed view 1500 of the subsystem (e.g., compressor 1100) including visual elements according to certain embodiments of this disclosure. The user may select any one or more of the parts shown in the multi-dimensional exploded detailed view 1500 to view a past, current, and/or projected state of the part. Further, the artificial intelligence vision system 106 may be configured and communicatively coupled to a controller of the compressor 1100 to dynamically control any selected part or portion of the compressor 1100 in real-time or near real-time using the interactive user interface 160, 162. Further, each virtual object and/or visual element associated with the parts may be synchronized based on the access control rules for each role of each user using the computing devices 12, 14.

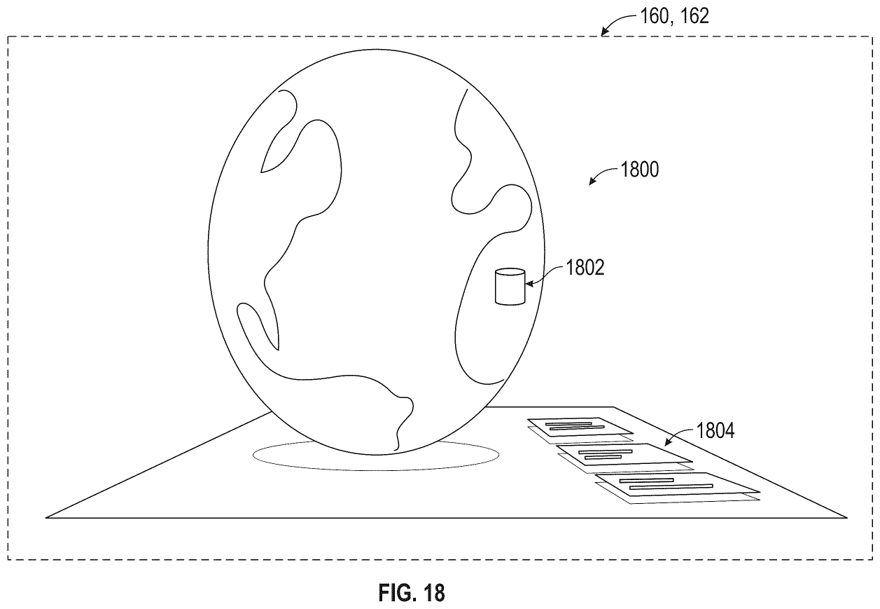

FIGS. 18-21 are now explained using a role of a supply chain manager as an example. In some embodiments, any graphical element presented via the user interfaces 160, 162, such as virtual objects and/or visual elements in a multi-dimensional virtual environment may be synchronized by the synchronization manager 107 depending on access control rules for each user using the computing devices 12-N and 14-N. Further, the synchronization manager 107 may synchronize the graphical elements (e.g., virtual objects, visual elements, augmented objects, mixed reality objects, etc.) between display areas associated with different enterprise applications presented in the user interfaces 160, 162. Thus, the graphical elements (e.g., virtual objects, visual elements, etc.) may be referred to as synchronized elements herein. The enterprise applications may be locally executed via the computing devices 12-N, 14-N and/or may be executed via the cloud-based computing system 116.

FIG. 18 illustrates another example user interface 160, 162 of an artificial intelligence vision system 106 depicting a global virtual map 1800 illustrating assets 1802 that may include potential maintenance and a parts inventory 1804 including visual elements according to certain embodiments of this disclosure. In the depicted example, a supply chain manager may compare parts required for maintenance or predicted maintenance with a parts inventory 1804 on a periodic basis (e.g., hourly, daily, weekly, monthly, etc.) to ensure the enterprise has sufficient parts in stock at any given time to conduct routine maintenance as well as any requested predictive maintenance generated by the one or more computer-implemented models 154. The parts inventory 1804 may include one or more virtual elements representing a part list for a certain subsystem (e.g., compressor) located at an asset (e.g., factory). The user may use one or more input devices to select and order any one or more of the parts included in the parts inventory 1804 in real-time or near real-time as predictive insights are generated or as desired.

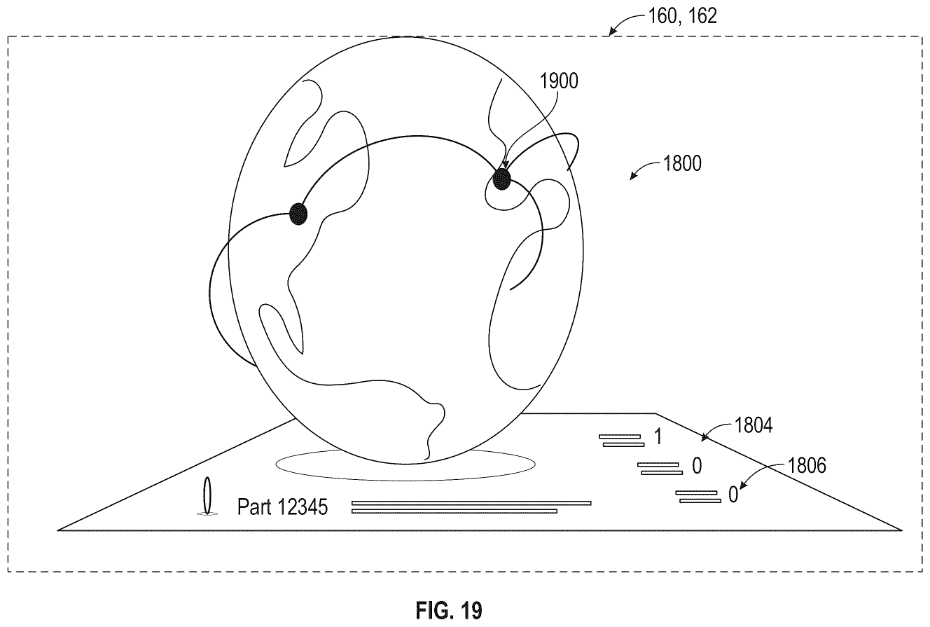

FIG. 19 illustrates another example user interface 160, 162 of an artificial intelligence vision system 106 depicting a global virtual map 1800 including a predictive insight (e.g., alert 1900) indicating sufficient parts for a work order according to certain embodiments of this disclosure. The user interface 160, 162 presented on the computing devices 12, 14 depicts, in this example, that an urgent work order was placed for “Part 12345” recently and the parts inventory 1804 is lacking the desired part (e.g., represented as quantity of “0” in the FIG. 19) at the inventory 1806 associated with the asset at which it is needed.

The artificial intelligence vision system 106 may access the database 129 which stores a multitude of data pertaining to each assets' inventory (e.g., systems, subsystems, parts, components, locations, configurations, etc.) and statuses related to the inventories. For example, the artificial intelligence vison system 106 may track past states, current states, and projected states of the inventories correlated with various times (e.g., hours, days, months, years, etc.) and factors (e.g., demand from customers, weather, economy, etc.). The one or more trained models 154 may input the data related to the inventories and may output the predictive insight related to the work order and the insufficient parts. As depicted, the user interface 106, 162 may present a graphical element, such as a three-dimensional list, of the inventories associated with every asset of an enterprise. The user may interact with the graphical element to view which asset includes the part(s) desired for a work order in order to perform the predicted maintenance. Further, the view of the inventories may be provided in real-time or near real-time to ensure that users of the artificial intelligence vision system 106 are kept up to date with the latest statuses of their assets' inventories.

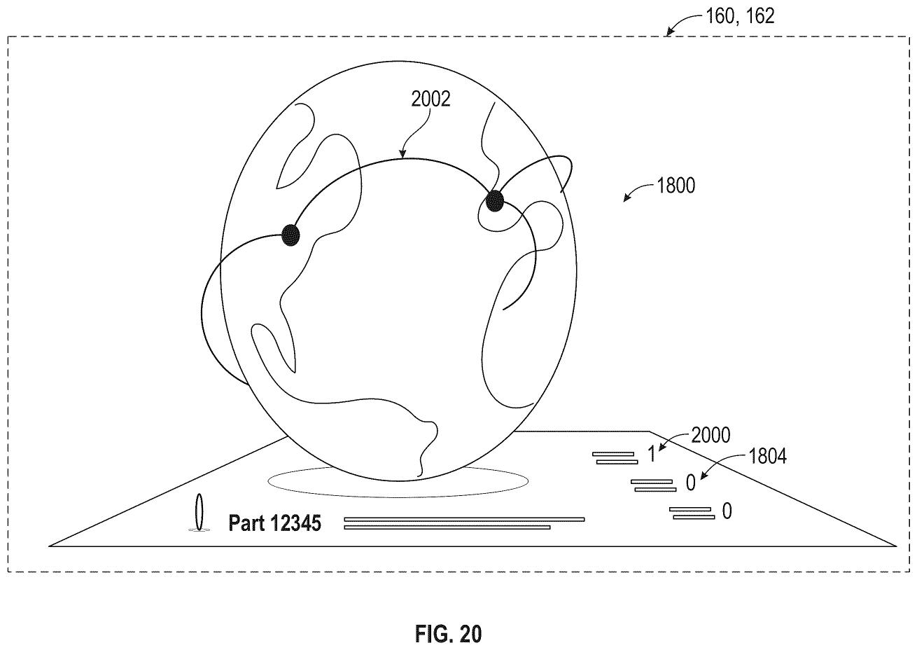

FIG. 20 illustrates another example user interface 160, 162 of an artificial intelligence vision system 106 depicting a global virtual map 1800 including an inventory view and routes 2002 including active shipments according to certain embodiments of this disclosure. The user may be presented with an inventory 2000 in the parts inventory 1804 that is associated with another asset (presented as quantity “1”) in the depicted example. The depicted inventory view presents the global virtual map 1800 of an enterprise's inventory across warehouses and facilities (e.g., assets). Further, the user interface 160, 162 may present visualizations of routes where there are active shipments in order to enable the user to select the quickest route to obtain a desired part.

In some embodiments, the artificial intelligence vision system 106 may access route information stored in the database for each of the assets associated with the enterprise. In some embodiments, the artificial intelligence vision system 106 may receive the route information and active shipments (e.g., global position of the shipments) via one or more data sources (e.g., application programming interfaces, systems, etc.). The user interface 160, 162 may present a real-time or near real-time visualization of the available shipping routes and the active shipments on the global virtual map 1800. A user may interact with the global virtual map 1800, for example, by rotating the global virtual map 1800 and the synchronization manager 107 may generate synchronization instructions to transmit to each device that is subscribed to or sharing the multi-dimensional virtual environment. The synchronization instructions may cause the computing devices 14 sharing the multi-dimensional virtual environment to update their user interfaces 160, 162 to rotate the global virtual map 1800. In some embodiments, if the global virtual map 1800 is being shared by several enterprise applications executing on the same computing device 12, the synchronization manager 107 may generate instructions that cause each of the respective enterprise applications to rotate their own instance of the global virtual map 1800 presented in a display area associated with the respective enterprise applications on the user interfaces 160, 162.

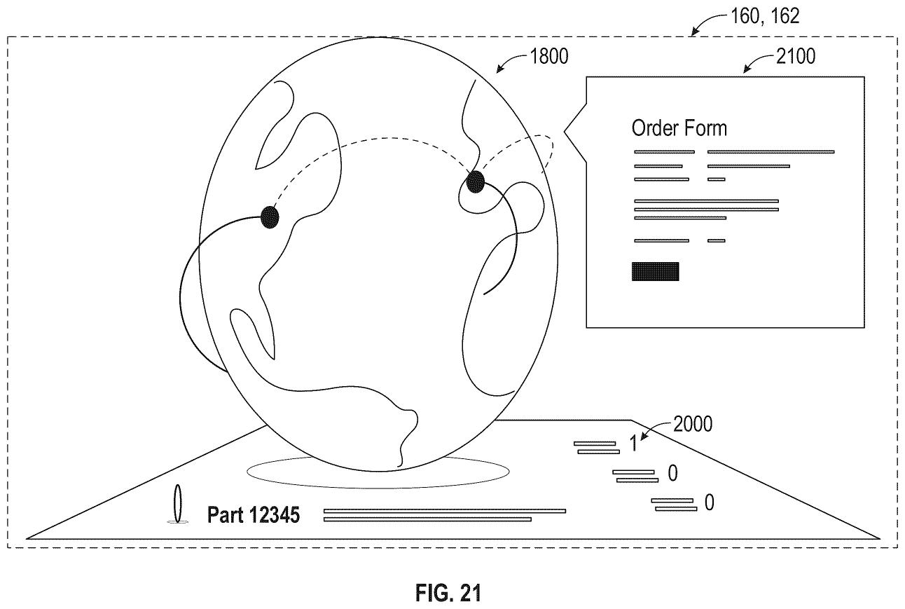

FIG. 21 illustrates another example user interface 160, 162 of an artificial intelligence vision system 106 depicting a global virtual map 1800 including a shipment form 2100 according to certain embodiments of this disclosure. The user may use an input device to select a route to ship a selected part from an asset that has the part in its inventory to the asset that needs the part.

The shipment form 2100 may be automatically generated by the artificial intelligence vision system 106 in response to a user selecting the inventory 2000 at which the part is available. In order to automatically generate the shipment form 2100, the artificial intelligence vision system 106 may retrieve information related to the receiving asset (e.g., address, identification, etc.), the part (e.g., type, quantity, name, status, etc.), the shipping asset (e.g., address, identification, etc.) where the part is available, and the like from the database 129.

Further, the user may select, using an input device and the globe virtual map 1800, a desired shipping route from the inventory 2000 to the desired asset. Further, the user may select the shipment form 2100 that is presented via the user interface 160, 162 to enable the user to drilldown to view one or more details or views related to the shipment. For example, other views may be presented that present more granular and/or detailed views of the part(s) that are being shipped from one asset to the desired asset. If the user confirms the shipment, the shipment form 2100 may be transmitted to one or more shipping entities to cause the requested “Part 12345” to be shipped to the desired location.

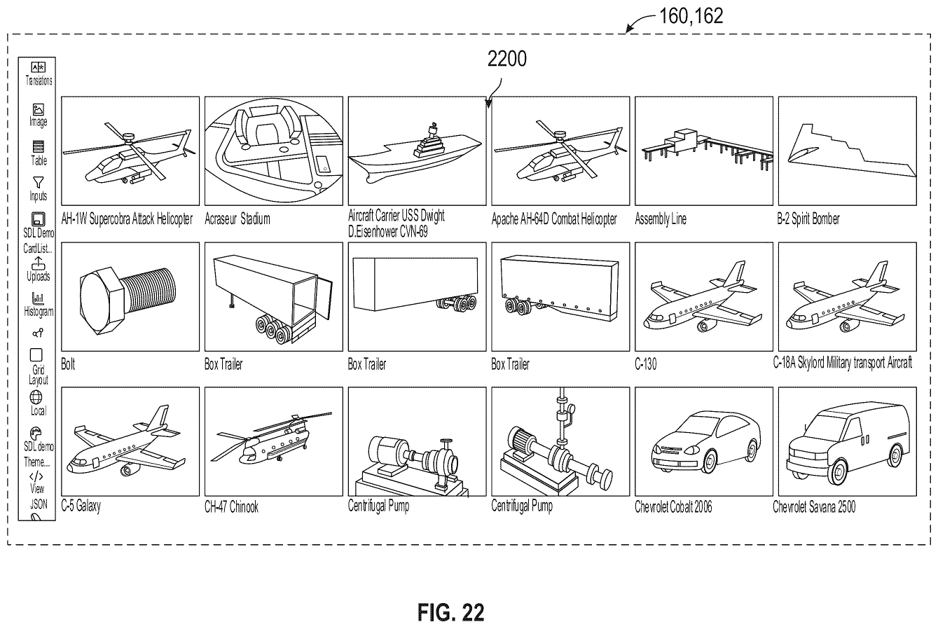

FIG. 22 illustrates another example user interface 160, 162 of an artificial intelligence vision system 106 depicting a three-dimensional object model library 2200 according to certain embodiments of this disclosure. The three-dimensional object models may be uploaded and/or dynamically generated based on one or more images, videos, and/or audio samples. Example object models may include vehicles, buildings, roads, parking lots, electrical devices, mechanical devices, machines, robots, containers, etc. The object models may be selected (e.g., via drag and drop) to be inserted and/or placed at desired locations within a multi-dimensional virtual environment representing a real-world physical environment. For example, a map of a factory may be uploaded to the artificial intelligence vision system 106, which may execute one or more computer-implemented models 154 trained to identify objects and locations of the objects in the map and generate one or more virtual objects to be places at the corresponding locations in a multi-dimensional virtual environment.

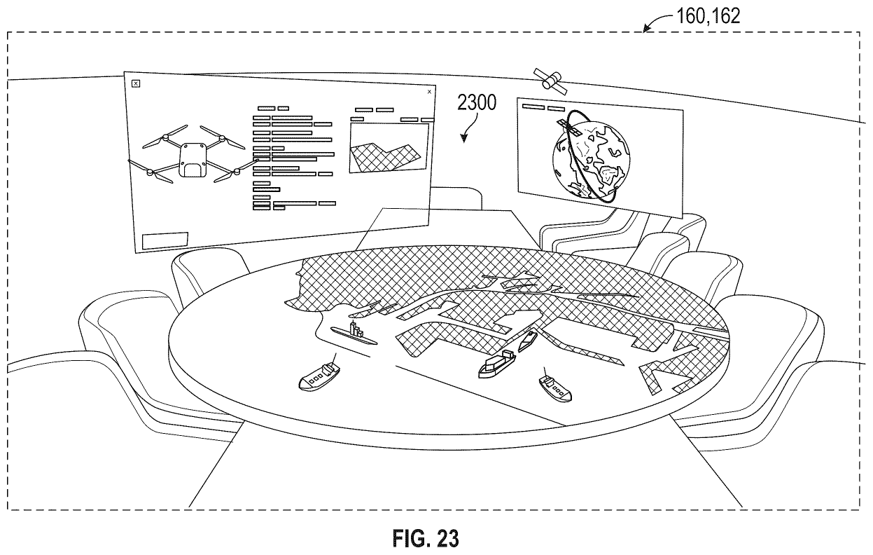

FIG. 23 illustrates another example user interface 160, 162 of an artificial intelligence vision system 106 depicting an artificial intelligence enterprise augmented reality environment or multi-dimensional virtual environment 2300 including synchronized elements in a plurality of augmented reality screens and augmented reality object-integrated images according to certain embodiments of this disclosure. The synchronized elements may be presented in different display areas within a single user interface 160, such that if a user modifies one of the synchronized elements (e.g., rotates a plane virtual object) in one display area associated with an enterprise application, the same synchronized element is modified in one or more display areas associated with one or more enterprise applications executing via the computing device 12, 14 and/or the cloud-based computing system 116.

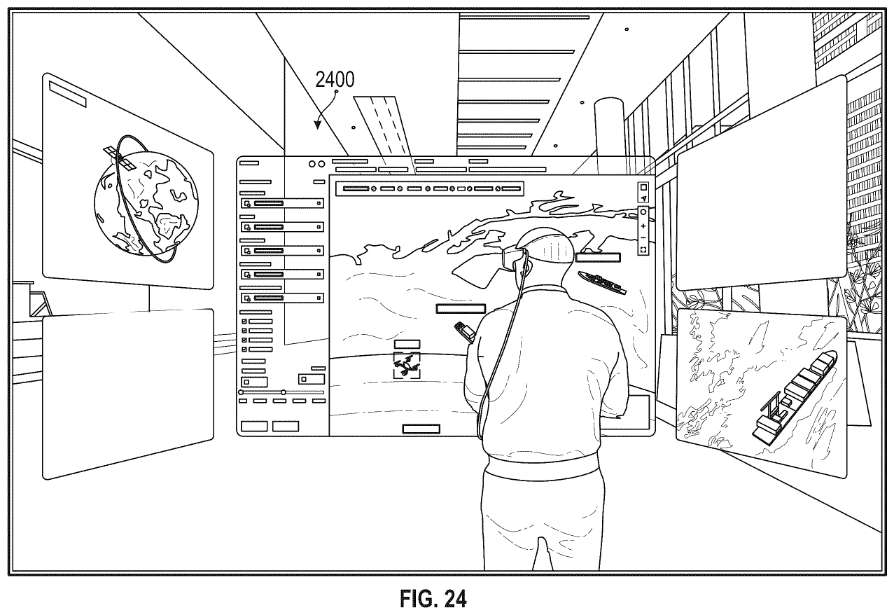

FIG. 24 illustrates another example user interface 160, 162 of an artificial intelligence vision system 106 depicting an artificial intelligence enterprise augmented reality environment presented via a computing device 12, 14 according to certain embodiments of this disclosure. In the example of FIG. 24, the artificial intelligence enterprise augmented reality environment includes multiple augmented reality screens, each presenting a different level of granular viewpoints. For example, an overview view of a virtual globe is shown, a more zoomed in view of a selected portion of the globe is shown, and a further zoomed in view of a selected asset (e.g., ship) is shown. Although a certain number of augmented reality screens are shown here, the artificial intelligence enterprise augmented reality environment may include any number of such screens. The user can interact with each screen in each display area and some of the elements may be synchronized with the other augmented reality screens based on access control rules for roles of each of the users.

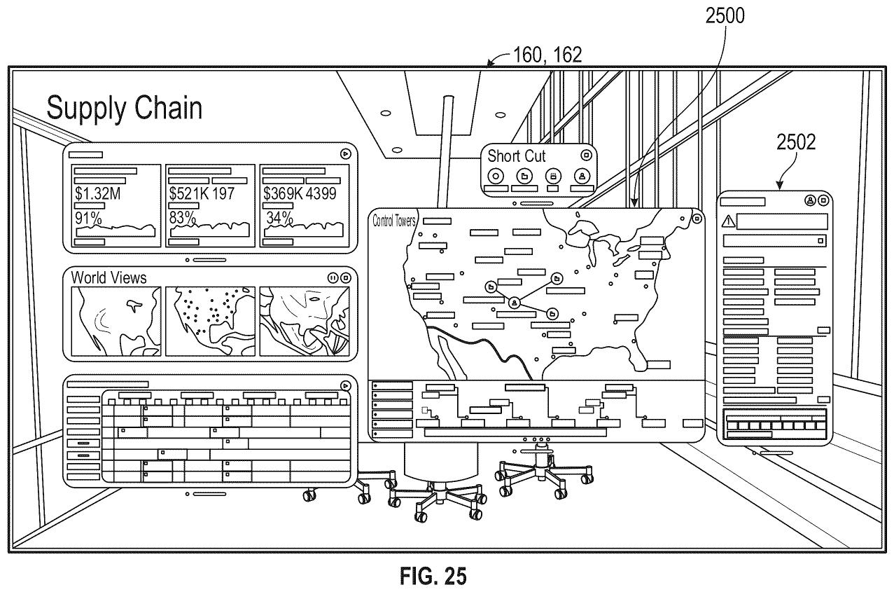

FIG. 25 illustrates another example user interface 160, 162 of an artificial intelligence vision system 106 depicting an artificial intelligence enterprise augmented reality environment or multi-dimensional virtual environment 2400 for a supply chain artificial intelligence application presented to one or more users on computing devices 12, 14 according to certain embodiments of this disclosure. For example, the multi-dimensional virtual environment 2400 may be presented to one or more users on corresponding user devices (e.g., follower user devices 14-N and/or leader user device 12). Each of the augmented reality screens may be rendered independently of the other screens. Each of the augmented reality screen may correspond to a portion (e.g., thread) of one or more artificial intelligence applications (e.g., an artificial intelligence application provided using a model-driven architecture). the one or more artificial intelligence applications may be implemented in computer instructions stored on one or more memory devices and executed by one or more processing devices. As shown, one or augmented reality screens includes an overview augmented reality screen 2500 and an alert augmented reality screen 2502 among other augmented reality screens. This overview augmented reality screen 2500 and alert augmented reality screen 2502 may be generated dynamically and can be updated automatically (e.g., in real-time). The artificial intelligence vision system 106 may use generative artificial intelligence methodologies to create the overview, alerts, and/or other content of other augmented reality screens of the artificial intelligence enterprise augmented reality environment or multi-dimensional virtual environment 2400.

In an example implementation, generative artificial intelligence system connects to one or more virtual metadata repositories across data stores, abstracts access to disparate data sources and supports granular data access controls is maintained by the enterprise artificial intelligence system. The enterprise generative artificial intelligence framework can manage a virtual data lake with an enterprise catalogue that connect to a multiple data domains and industry specific domains. An orchestrator can employ a system of agents to retrieve, process data with a collection of tool perform operations and calculations. The orchestrator of the enterprise generative artificial intelligence framework is able to create embeddings for multiple data types across multiple industry verticals and knowledge domains, and even specific enterprise knowledge. Embedding of objects in data domains of the enterprise information system enable rapid identification and complex processing with relevance scoring as well as additional functionality to enforce access, privacy, and security protocols. In some implementations, the orchestrator module can employ a variety of embedding methodologies and techniques understood by one of ordinary skill in the art. In an example implementation, the orchestrator module can use a model driven architecture for the conceptual representation of enterprise and external data sets and optional data virtualization. For example, a model driven architecture can be as described in U.S. Pat. No. 10,817,530 issued Oct. 27, 2020, Ser. No. 15/028,340 with priority to Jan. 23, 2015 titled Systems, Methods, and Devices for an Enterprise Internet-of-Things Application Development Platform by C3 AI, Inc. A type system of a model driven architecture can used to embed objects of the data domains.

The model driven architecture handles compatibility for system objects (e.g., components, functionality, data, etc.) that can be used by the orchestrator to dynamically generate queries for conducting searches across a wide range of data domains (e.g., documents, tabular data, insights derived from AI applications, web content, or other data sources). The type system provides data accessibility, compatibility and operability with disparate systems and data. Specifically, the type system solves data operability across diversity of programming languages, inconsistent data structures, and incompatible software application programming interfaces. Type system provides data abstraction that defines extensible type models that enables new properties, relationships and functions to be added dynamically without requiring costly development cycles. The type system can used as a domain-specific language (DSL) within a platform used by developers, applications, or UIs to access data. The type system provides interact ability with data to perform processing, predictions, or analytics based on one or more type or function definitions within the type system. The orchestrator is a mechanism for implementing search functionality across a wide variety of data domains relative to existing query modules, which are typically limited with respect to their searchable data domains (e.g., web query modules are limited to web content, file system query modules are limited to searches of file system, and so on).

Type definitions can be a canonical type declared in metadata using syntax similar to that used by types persisted in the relational or NoSQL data store. A canonical model in the type system is a model that is application agnostic (i.e., application independent), enabling all applications to communicate with each other in a common format. Unlike a standard type, canonical types are comprised of two parts, the canonical type definition and one or more transformation types. The canonical type definition defines the interface used for integration and the transformation type is responsible for transforming the canonical type to a corresponding type. Using the transformation types, the integration layer may transform a canonical type to the appropriate type.

The model-driven architecture and type system can significantly enhance the AI Vision system by providing a robust framework for data interoperability and compatibility across diverse systems. This architecture allows for seamless integration of various data sources, enabling the AI Vision system to process and analyze data from multiple domains efficiently. The type system, with its extensible type models, ensures that new properties, relationships, and functions can be added dynamically without requiring extensive development cycles. This flexibility is crucial for the AI Vision system as it adapts to evolving enterprise needs and integrates new technologies. Additionally, the model-driven architecture supports the creation of digital twins and multi-dimensional virtual environments, which are essential for real-time visualization and interaction with enterprise assets.

Time-series data refers to a sequence of data points collected or recorded at specific time intervals, often used to track changes over time. The technical benefits of time-series analysis include the ability to forecast future trends, detect anomalies, and understand seasonal patterns, which can be crucial for decision-making in various fields such as finance, healthcare, and manufacturing. Challenges such as handling missing data, managing large volumes of data, and ensuring the accuracy of long-term predictions can complicate the analysis. Additionally, time-series data often assumes linear relationships, which may not always hold true in real-world scenarios. The agentic framework, which employs autonomous agents to perform tasks, can leverage time-series data to enhance its decision-making capabilities. For instance, by using machine learning models, an agentic system can predict future events based on historical data, allowing it to take proactive measures. These systems can also use time-series data to monitor and optimize the performance of various assets, such as industrial equipment or financial portfolios. Moreover, integrating time-series data with other data sources, such as textual descriptions or sensor data, can provide a more comprehensive understanding of the underlying patterns and trends3. This integration can improve the interpretability and explainability of the results generated by the agentic system, making it more reliable and effective. Overall, while time-series analysis presents certain challenges, its benefits and applications in agentic systems make it a valuable tool for various industries.

The AI Vision system is designed to handle time-series data effectively by integrating various data sources and providing real-time or near real-time visualizations. This capability allows the system to process and analyze continuous data streams, such as sensor readings, performance metrics, and machine health status, which are crucial for making timely decisions and proactive maintenance. The system's ability to synchronize and harmonize data from multiple modalities, including text, images, and geo-spatial data, enhances its accuracy and reliability. Additionally, the AI Vision system's use of digital twins and multi-dimensional virtual environments enables users to interact with and manipulate real-time data, providing a comprehensive view of enterprise assets. These technical advantages facilitate improved situational awareness, faster decision-making, and optimized operational efficiency.

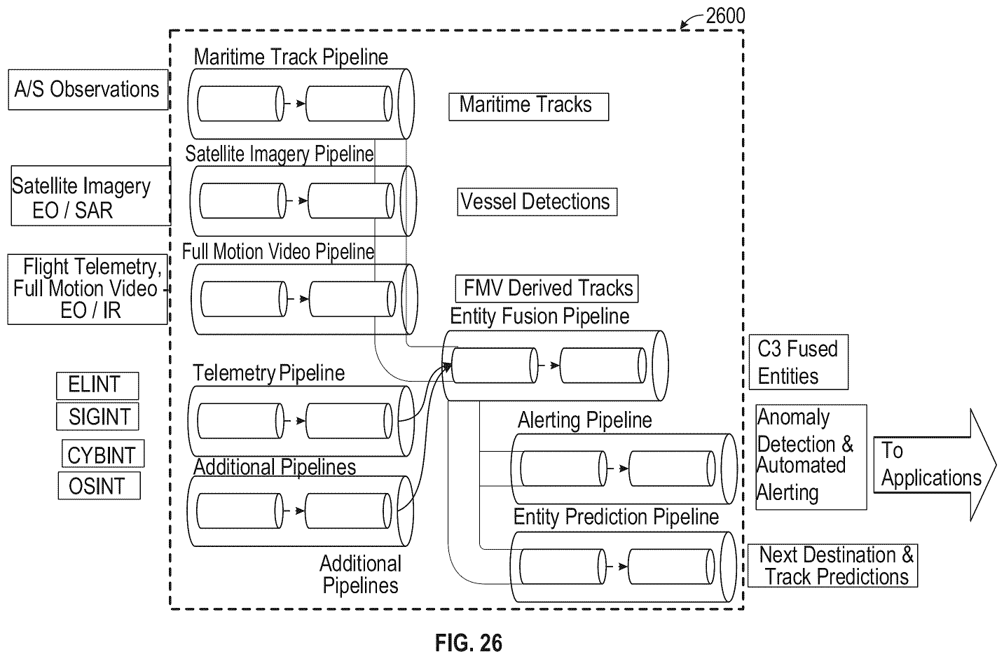

FIG. 26 illustrates a diagram of data and machine learning pipelines 2600 for multi-model entity fusion according to certain embodiments of this disclosure. In the example of FIG. 26, the pipelines 2600 include a maritime track pipeline, a satellite imagery pipeline, a full motion video pipeline, a telemetry pipeline, additional pipelines, an entity fusion pipeline, an alerting pipeline, and an entity prediction pipeline. Each pipeline may include one or more computer-implemented models executed by the artificial intelligence vision system 106.

The maritime track pipeline may receive automatic identification system observations as input and may output maritime tracks. The satellite imagery pipeline may receive satellite imagery as input and may output vessel detections. The full motion video pipeline may receive flight telemetry, full motion video, electro-optical/infra-red data, etc. as input and output full motion video derive tracks

The telemetry pipeline and additional pipelines may receive electronic intelligence (ELINT), signal intelligence (SIGINT), cyber intelligence (CYBINT), open-source intelligence (OSINT), and the like as input and may output derived tracks of vehicles. Each output from the maritime track pipeline, the satellite imagery pipeline, the full motion video pipeline, the telemetry pipeline, and the additional pipelines may be input into the entity fusion pipeline which uses one or computer-implemented models to generated fused entities. Also, the outputs from the various pipelines may be input into the alerting pipeline which uses one or more computer-implemented models to detect anomalies and provides automated alerts. Additionally, the outputs from the various pipelines may be input into the entity prediction pipeline which may predict the next destination and track predictions of one or more vehicles.

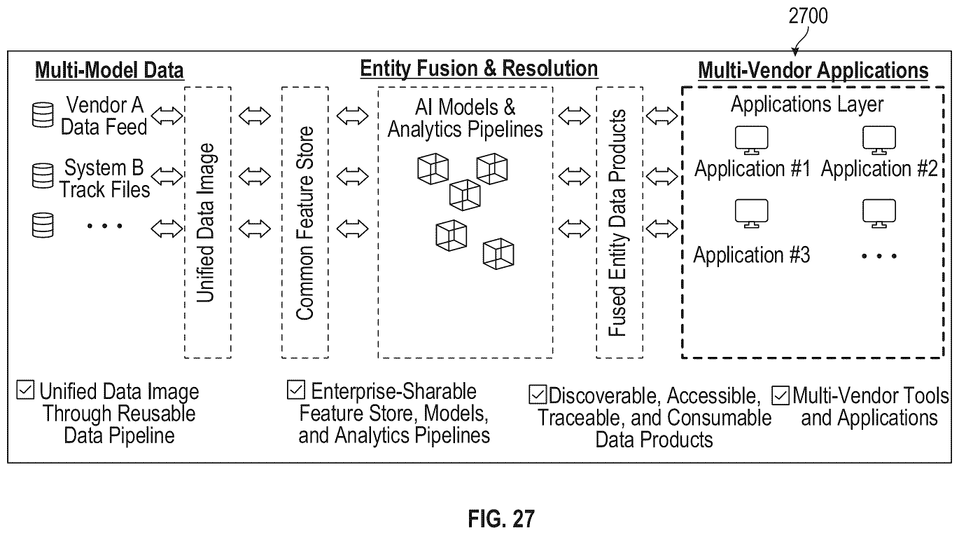

FIG. 27 illustrates a graphical representation 2700 of multi-modal entity fusion according to certain embodiments of this disclosure. Multi-modal entity fusion can fuse data from disparate sensors (e.g., satellites, sensors, cameras, microphones, etc.) and systems to provide actionable ground-truth data (e.g., that a ship is the same ship across different sensor data). This can allow the artificial intelligence vision system 106 to leverage data captured by any number and any type of disparate sensor. The data received from the disparate sensors and/or systems may be received in disparate data formats. The artificial intelligence vision system 106 may transform the data using one or more data schemas and/or mapping techniques to normalize the disparate data formats to a standardized data format that may be used by the one or more computer-implemented models 154.

As depicted, multi-modal data may be received from various data sources, such as vendor A data feed, system B track files, etc. and the artificial intelligence vision system 106 may transform the disparate data into a unified data image for use in a reusable data pipeline. Further, a common feature store may be implemented in the database 129. The common feature store may be an enterprise-shareable feature store of object models and analytics pipelines. The artificial intelligence vision system 106 may execute one or more computer-implemented models in the described pipelines to perform entity fusion to output fused entity data products (e.g., discoverable, accessible, traceable, and consumable data products). The artificial intelligence vision system 106 may provide multi-vendor applications in an application layer. These applications may be enterprise applications that are executable via the one or more computing devices 12-N, 14-N which present any of the user interfaces disclosed herein.

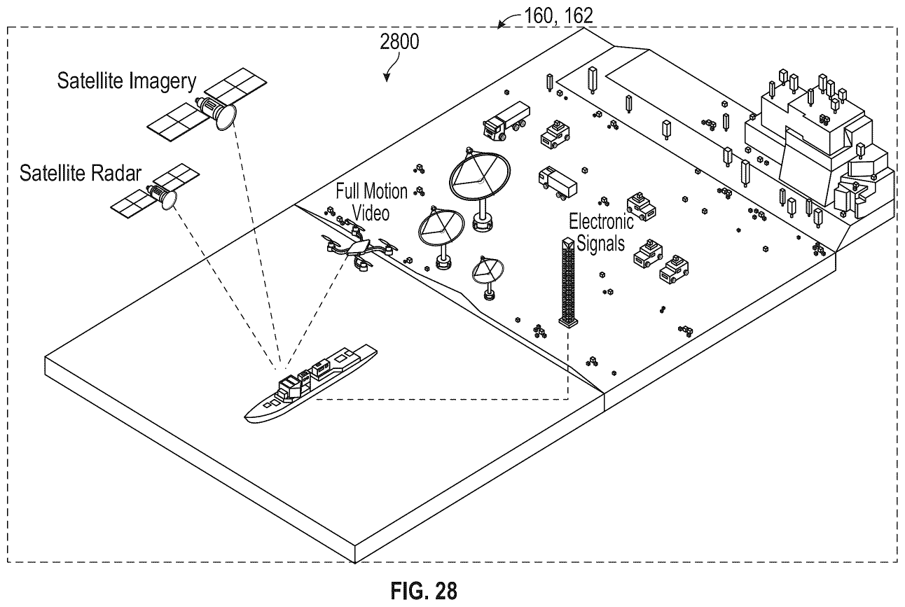

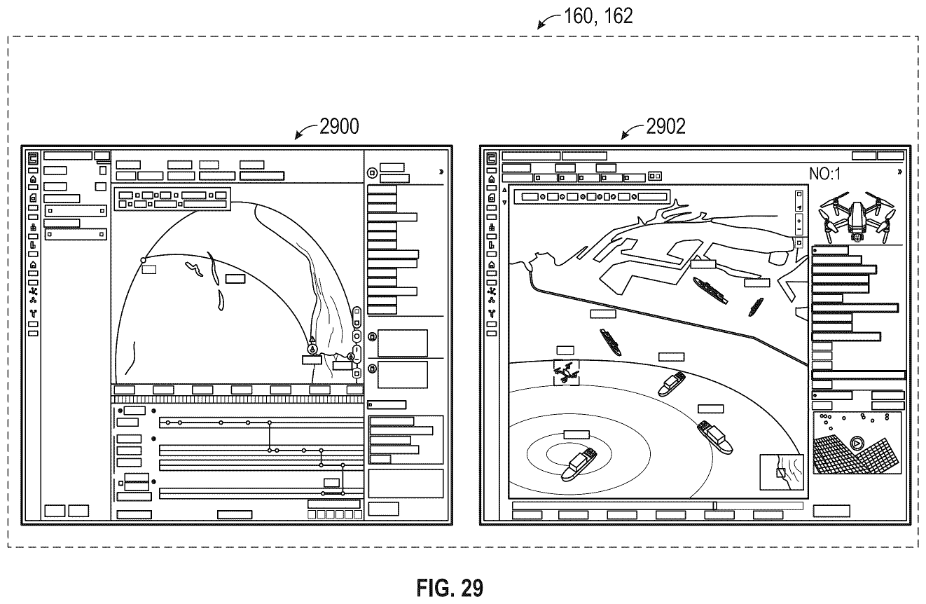

FIG. 28 illustrates another example user interface 160, 162 of an artificial intelligence vision system 106 depicting an artificial intelligence enterprise augmented reality environment or multi-dimensional virtual environment 2800 presented via a computing device 12, 14 according to certain embodiments of this disclosure. FIG. 29 illustrates another example user interface 160, 162 of an artificial intelligence vision system 106 depicting an artificial intelligence enterprise augmented reality environment or multi-dimensional virtual environment presented via a computing device 12, 14.

The augmented reality screens 2900 and 2902 in the user interface 160, 162 include real-time data visualizations that enable users to view real-time data streams, such as sensor readings, performance metrics, and/or machine health status overlaid on physical assets, enabling faster decision-making and proactive maintenance. For example, the user may select any virtual object representing a physical object from the user interface 160, 162 to perform one or more actions (e.g., control operation of the physical object, change an operating parameter of the physical object, etc.).

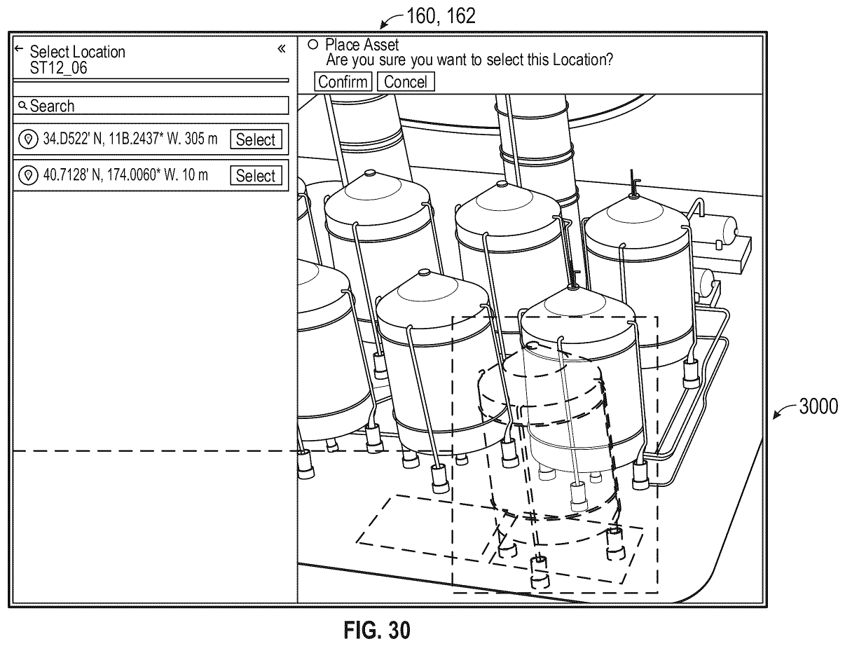

FIG. 30 illustrates another example user interface 160, 162 of an artificial intelligence vision system 106 for configuring a digital twin 3000 of an asset using one or more object models according to certain embodiments of this disclosure. The user interface 160, 162 enables a user to configure a digital twin 3000 using one or more object models. As shown, the user may drag and drop a desired object model (e.g., a silo) to a desired location that corresponds to a real-world physical location of the physical object (e.g., actual silo). In some embodiments, users may upload enterprise object models or pick from the object model library. The user interface 160, 162 in the FIG. 30 may enable a user to verify placement and finish mapping the object model to the asset to generate a digital model. Further, the user may configure various parameters, such as connection settings, operating parameters, and the like. In some embodiments, one or more application programming interfaces may expose one or more (e.g., thousands, millions, etc.) multi-dimensional object models via an online marketplace (e.g., for downloading and use by enterprises to configure their assets). Further, the artificial intelligence vision system 106 may enable automatic model recommendation for assets using one or more computer-implemented models 154 based on input images, video, audio, etc. The artificial intelligence vision system 106 may use generative artificial intelligence for generating multi-dimensional object models. In addition, the artificial intelligence vision system 106 may execute photogrammetry (three dimensional object and space scanning) to generate a digital twin virtual environment of a physical environment in real-time or near real-time.

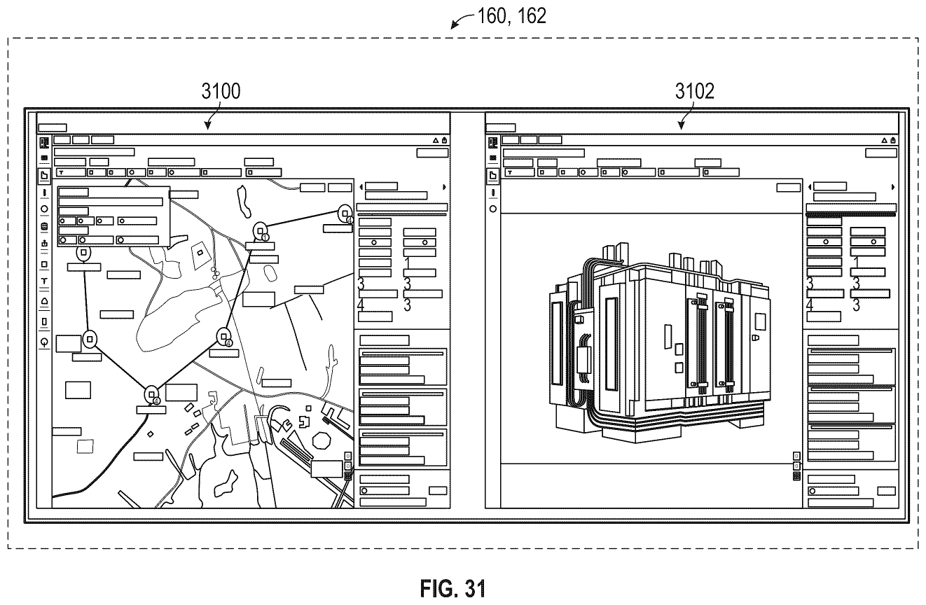

FIG. 31 illustrates another example user interface 160, 162 of an artificial intelligence vision system 106 depicting an artificial intelligence enterprise augmented reality environment or multi-dimensional virtual environment presented via a computing device according to certain embodiments of this disclosure. As depicted, a supply chain is presented in one display area 3100 executed by one enterprise application, and the supply chain includes one or more predictive insights represented by visual elements. In addition, a more detailed and zoomed in view is presented in another display area 3102 of the user interface 160, 162 that presents a virtual object of a physical object at an asset along the supply chain. The users may interact with any graphical element presented in the user interface of the multi-dimensional virtual environment 3100 to perform one or more actions.

In some embodiments, the artificial intelligence vision system 106 may improve accessibility to enterprise artificial intelligence data through a visual-driven interface. The artificial intelligence vision system 106 may enhance user efficiency with immersive and interactive three-dimensional interactions. Further, the artificial intelligence vision system 106 may uncover new insights via intuitive, artificial intelligence driven visualizations. Also, the artificial intelligence vision system 106 may increase usability by standardizing data visualizations across enterprise applications. In addition, the artificial intelligence vision system 106 may extend two-dimensional displays to virtual reality devices, mixed reality devices, and/or augmented reality devices.

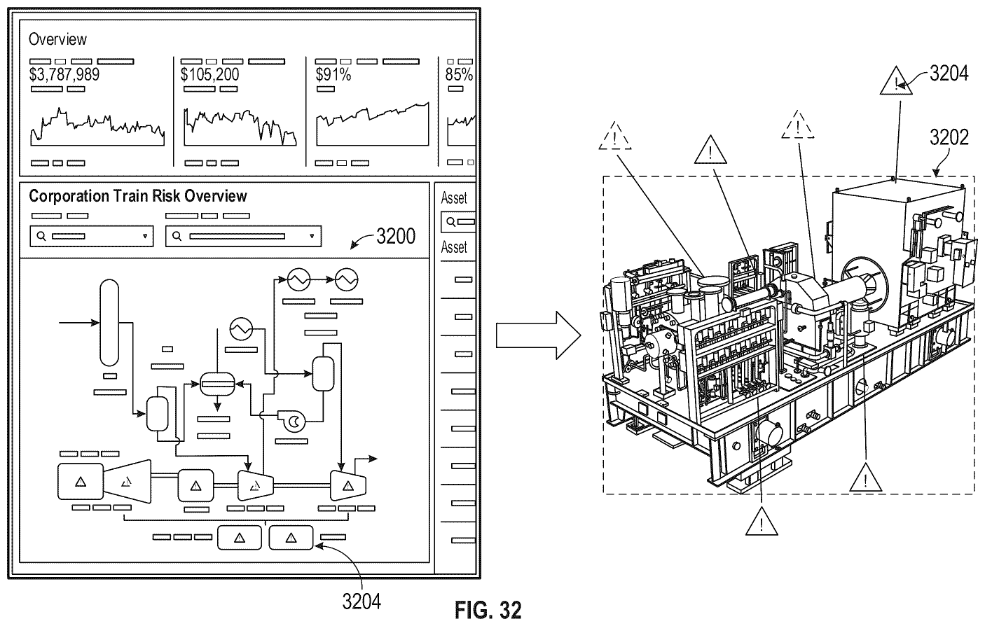

FIG. 32 illustrates a diagram of an artificial intelligence vision system 106 generating a three-dimensional virtual object 3202 using a two-dimensional schematic 3200 according to certain embodiments of this disclosure. As depicted, the artificial intelligence vision system 106 may contextualizes two-dimensional schematics with intuitive, real-world three-dimensional object model representations. The two-dimensional schematic depicted includes alerts 3204 associated with various objects (e.g., gas generator, power turbine, gear box, export compressor, etc.), which are processed by one or more computer-implemented models 154 of the artificial intelligence vision system 106 to generate the three-dimensional virtual object 3202 with the corresponding alerts 3204 at the appropriate portions of the three-dimensional virtual object 3202. In addition, the artificial intelligence vision system 106 may provide one or more enterprise insights by executing one or more computer-implemented models 154 that generate a predicted value of avoided downtime, a value of production at risk, a percentage of asset uptime, among other things.

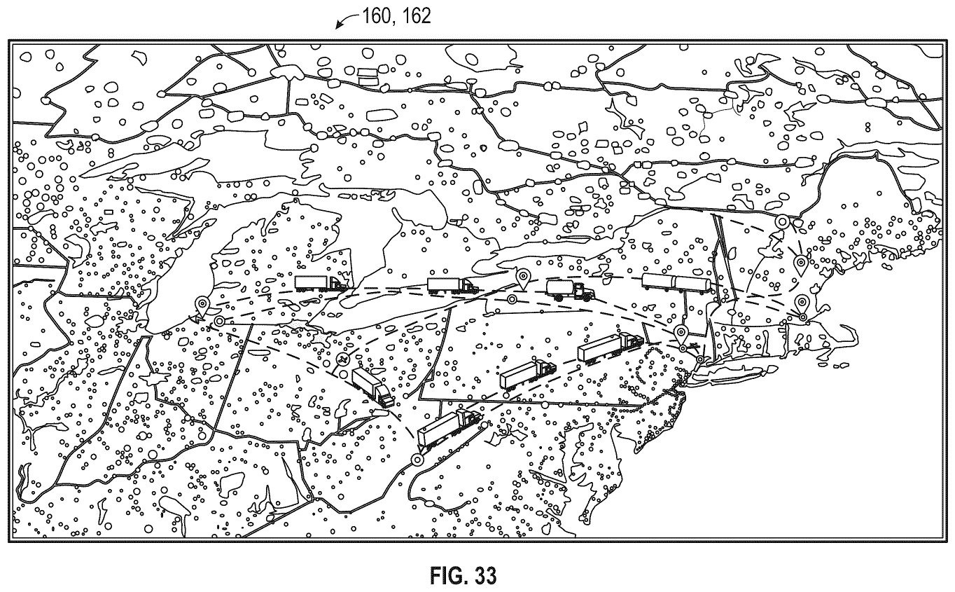

FIG. 33 illustrates another example user interface of an artificial intelligence vision system depicting a three-dimensional geospatial view and interactive interfaces with supply chain networks according to certain embodiments of this disclosure. As depicted, the three-dimensional geospatial view and interactive interfaces with supply chain networks may enable optimal decision making, mitigate supply chain network risks, and optimize inventory distribution and management. The user interface 160, 162 in FIG. 33 presents numerous virtual routes representing actual routes and virtual objects of trucks representing actual trucks and their geographical location at the current point in time. This augmented reality view of various supply vehicles in transit may enable a user to see in real-time where certain loads and/or packages are and how close they are to arrival at their destination. Further, a user may select any one of the virtual objects representing the trucks and may directly communicate with a user's computing device of that vehicle and/or control that vehicle by transmitting one or more control instructions to the vehicle via the artificial intelligence vision system 106. One or more users of the computing devices viewing the user interface 160, 162 may select any virtual object depicted to perform one or more actions. Further, as depicted one or more visual elements associated with predictive insights may be presented and selected by the user in real-time or near real-time to manage a supply chain.

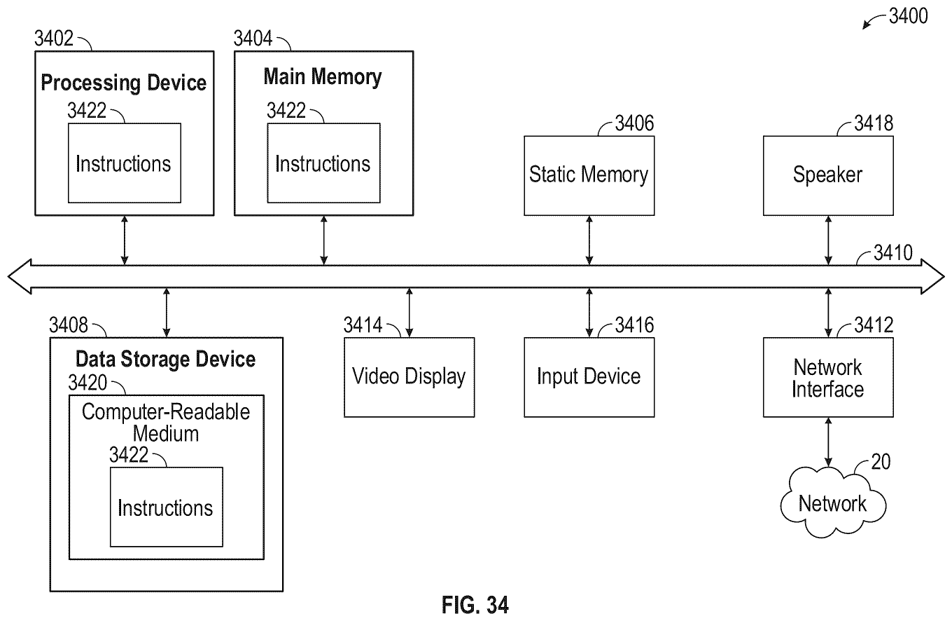

FIG. 34 illustrates an example computer system 3400, which can perform any one or more of the methods described herein. In one example, computer system 3400 may include one or more components that correspond to the one or more computing devices 12, one or more computing devices 14, one or more servers 128 of the cloud-based computing system 116, one or more artificial intelligence vision systems 106 of the cloud-based computing system 116, one or more computer-implemented models 154 of the cloud-based computing system 116, or one or more AI applications 170 of the cloud-based computing system of FIG. 1. The computer system 3400 may be connected (e.g., networked) to other computer systems in a LAN, an intranet, an extranet, or the Internet. The computer system 3400 may operate in the capacity of a server in a client-server network environment. The computer system 3400 may be a personal computer (PC), headset, a virtual reality device, an augmented reality device, a mixed reality device, a BCI, contact lens, goggles, a monocle, glasses, a tablet computer, a laptop, a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein. The computer system 3400 includes a processing device 3402, a main memory 3404 (e.g., read-only memory (ROM), solid state drive (SSD), flash memory, dynamic random access memory (DRAM) such as synchronous DRAM (SDRAM)), a static memory 3406 (e.g., solid state drive (SSD), flash memory, static random access memory (SRAM)), and a data storage device 3408, which communicate with each other via a bus 3410.

Processing device 3402 represents one or more general-purpose processing devices such as a microprocessor, central processing unit, or the like. More particularly, the processing device 3402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 3402 may also be one or more special-purpose processing devices may include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application specific integrated circuits (ASICs), field programmable gate arrays (FPGAs), or discrete circuitry.

The computer system 3400 may further include a network interface device 3412. The computer system 3400 also may include a video display 3414 (e.g., a liquid crystal display (LCD) or a cathode ray tube (CRT)), one or more input devices 3416 (e.g., a keyboard and/or a mouse), and one or more speakers 3418 (e.g., a speaker). In one illustrative example, the video display 3414 and the input device(s) 3416 may be combined into a single component or device (e.g., an LCD touch screen).

The data storage device 3416 may include a computer-readable medium 3420 on which the instructions 3422 embodying any one or more of the methodologies or functions described herein are stored. The instructions 3422 may also reside, completely or at least partially, within the main memory 3404 and/or within the processing device 3402 during execution thereof by the computer system 3400. As such, the main memory 3404 and the processing device 3402 also constitute computer-readable media. The instructions 3422 may further be transmitted or received over a network 20 via the network interface device 3412.

While the computer-readable storage medium 3420 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The various aspects, embodiments, implementations or features of the described embodiments can be used separately or in any combination. The embodiments disclosed herein are modular in nature and can be used in conjunction with or coupled to other embodiments, including both statically-based and dynamically-based equipment. In addition, the embodiments disclosed herein can employ selected equipment such that they can identify individual users and auto-calibrate threshold multiple-of-body-weight targets, as well as other individualized parameters, for individual users. The foregoing descriptions of specific embodiments are presented for purposes of illustration and description and are not intended to be exhaustive or to limit the described embodiments. Numerous variations and modifications will become apparent to those skilled in the art once the above disclosure is fully appreciated.

In some embodiments, a computer-implemented artificial intelligence vision system method includes generating, by one or more processing devices, a virtual spatial environment including one or more virtual objects depicting one or more enterprise assets associated with an enterprise machine-learning application. The enterprise machine-learning application employs machine-learning to generate artificial intelligence insights associated with the one or more enterprise assets. In response to receiving an input, the method includes causing, by the artificial intelligence vision system, presentation of one or more visual elements for an artificial intelligence insight associated with a particular virtual object, wherein the one or more visual elements indicate information regarding the corresponding enterprise asset of the particular virtual object.

In some embodiments, a computer-implemented method includes rendering, by one or more processing devices executing an artificial intelligence vision system, a multi-dimensional virtual environment including one or more virtual objects representing one or more physical objects. The multi-dimensional virtual environment is rendered based on a physical environment including the one or more physical objects. The computer-implemented method includes generating, using one or more computer-implemented models of the artificial intelligence vision system, one or more enterprise insights associated with at least the one or more virtual objects and causing, using the artificial intelligence vision system, presentation of one or more visual elements in conjunction with the one or more virtual objects. The one or more visual elements represent the one or more enterprise insights.

In some embodiments, the computer-implemented method includes receiving, at the one or more processing devices from one or more input devices, input from a user. The input pertains to a selected one of the one or more virtual objects or the one or more visual elements. Based on the input, the computer-implemented method includes performing, using the artificial intelligence vision system, an action associated with the selected one of the one or more virtual objects or the one or more visual elements.

The visual elements pertain to recommendations, results, actions, or some combination thereof, and the visual elements are generated via the one or more computer-implemented models. In some embodiments, the computer-implemented method includes rendering the multi-dimensional virtual environment based on a digital twin of the physical environment. In some embodiments, the one or more virtual objects are associated with at least one of a current, historical, and projected state of the one or more physical objects.

The one or more virtual objects rendered can be based on one or more access control rules for the user. In some embodiments, the one or more computer-implemented models are trained to generate the one or more enterprise insights based on one or more enterprise workflows, preferences of the user, historical usage patterns of the user, or some combination thereof. In some embodiments, the computer-implemented method includes synchronizing the one or more virtual objects between a set of display areas associated with a set of applications concurrently presented in a display of a computing device. In some embodiments, the computer-implemented method includes synchronizing, using the artificial intelligence vision system, the one or more visual elements within the multi-dimensional virtual environment presented via a set of computing devices associated with a set of users.

The computer-implemented method can include overlaying the multi-dimensional virtual environment at least partially on the physical environment visible through a computing device used by the user. In some embodiments, the one or more enterprise insights include statuses, alerts, messages, locations, parameters, values, vehicles, buildings, people, robots, machines, or some combination thereof. In some embodiments, the computer-implemented method includes receiving, via one or more input devices, a selection of at least one of the one or more visual elements associated with at least one physical object, and transmitting, to one or more processing devices associated with the at least one physical object, one or more control instructions to cause one or more modifications to operation of the at least one physical object. In some embodiments, the physical environment includes one or more buildings, vehicles, rooms, robots, machines, or some combination thereof. In some embodiments, the input comprises a query, and the computer-implemented method includes, based on the query, identifying, using one or more large language models, at least a subset of the one or more enterprise insights, and rendering the multi-dimensional virtual environment including at least a subset of the one or more virtual objects associated with the subset of the one or more enterprise insights. In some embodiments, the input includes limb gesture, appendage gesture, eye gaze, eye movement, head movement, voice, touch, noise, or some combination thereof.

An example computer-implemented method includes receiving, at one or more processing devices executing an artificial intelligence vision system, one or more enterprise insights. The one or more enterprise insights may be generated via one or more computer-implemented models. The method may include rendering, by the one or more processing devices, a multi-dimensional virtual environment including one or more virtual objects associated with the one or more enterprise insights. The multi-dimensional virtual environment may be rendered based on a digital twin of a physical environment representing at least one of a current, historical, and projected state of one or more physical objects. The method may include receiving, at the one or more processing devices from one or more input devices, input from the user. The input may pertain to the one or more virtual objects. The method may include, based on the input, presenting, using the artificial intelligence vision system, one or more visual elements pertaining to recommendations, results, actions, or some combination thereof. The visual elements may be generated via the one or more computer-implemented models.

In some embodiments, the one or more virtual objects are rendered based on one or more access control rules for the user. In some embodiments, the one or more computer-implemented models are trained to generate the one or more enterprise insights based on one or more enterprise workflows, preferences of the user, historical usage patterns of the user, or some combination thereof. In some embodiments, a computer-implemented method may include synchronizing the one or more virtual objects between a set of display areas associated with a set of applications concurrently presented in a display of a computing device. In some embodiments, a computer-implemented method may include synchronizing, using the artificial intelligence vision system, the one or more visual elements within the multi-dimensional virtual environment presented via a set of computing devices associated with a set of users. In some embodiments, a computer-implemented method may include overlaying the multi-dimensional virtual environment at least partially on a physical environment visible through a computing device used by the user. In some embodiments, the one or more enterprise insights comprise statuses, alerts, messages, locations, parameters, values, vehicles, buildings, people, robots, machines, or some combination thereof.

In some embodiments, the computer-implemented method may include receiving, via the one or more input devices, a selection of at least one of the one or more visual elements. The method may include transmitting, to one or more processing devices associated with the one or more physical objects, one or more control instructions to cause one or more modifications to operation of the one or more physical objects. In some embodiments, the physical environment includes one or more buildings, vehicles, rooms, robots, machines, or some combination thereof.

In some embodiments, the input includes a query, and a computer-implemented method includes, based on the query, identifying, using one or more large language models, at least a subset of the one or more enterprise insights. The method also includes rendering the multi-dimensional virtual environment including at least a subset of the one or more virtual objects associated with the subset of the one or more insights. In some embodiments, the input includes limb gesture, appendage gesture, eye gaze, eye movement, head movement, voice, touch, noise, or some combination thereof.

A tangible, non-transitory computer-readable medium stores instructions that, when executed, cause one or more processing devices to receive, at the one or more processing devices executing an artificial intelligence vision system, one or more enterprise insights. The one or more enterprise insights may be generated via one or more computer-implemented models. The processing devices may further render, by the one or more processing devices, a multi-dimensional virtual environment including one or more virtual objects associated with the one or more enterprise insights. The multi-dimensional virtual environment may be rendered based on a digital twin of a physical environment representing at least one of a current, historical, and projected state of one or more physical objects. The processing devices may further receive, from one or more input devices, input from the user. The input may pertain to the one or more virtual objects. The processing devices may further, based on the input, present, using the artificial intelligence vision system, one or more visual elements pertaining to recommendations, results, actions, or some combination thereof. The visual elements may be generated via the one or more computer-implemented models.

A system includes one or more memory devices storing instructions and one or more processing devices communicatively coupled to the one or more memory devices. The one or more processing devices may execute the instructions to receive, at the one or more processing devices executing an artificial intelligence vision system, one or more enterprise insights. The one or more enterprise insights may be generated via one or more computer-implemented models. The processing devices may further render, by the one or more processing devices, a multi-dimensional virtual environment including one or more virtual objects associated with the one or more enterprise insights. The multi-dimensional virtual environment may be rendered based on a digital twin of a physical environment representing at least one of a current, historical, and projected state of one or more physical objects. The processing devices may further receive, from one or more input devices, input from the user. The input may pertain to the one or more virtual objects. The processing devices may further, based on the input, present, using the artificial intelligence vision system, one or more visual elements pertaining to recommendations, results, actions, or some combination thereof. The visual elements may be generated via the one or more computer-implemented models.

A computer-implemented method may include receiving, from one or more data sources, data associated with a physical environment including one or more physical objects. At least a subset of the one or more data sources may be disposed at the physical environment. The method may include, based on the data, generating, using an artificial intelligence vision system, a digital twin virtual environment representing the physical environment in real-time or near real-time. The digital twin virtual environment may include one or more virtual objects representing the one or more physical objects. The method may include causing presentation of the digital twin virtual environment on a display of a computing device, receiving, at the artificial intelligence vision system from one or more input devices, input from a user. The input may pertain to at least one of the one or more virtual objects. The method may include, based on the input, presenting, using the artificial intelligence vision system, one or more visual elements pertaining to recommendations, results, actions, or some combination thereof.

The computer-implemented method may include establishing, via the artificial intelligence vision system, one or more communication connections with the one or more physical objects. Based on the input pertaining to the at least one of the one or more virtual objects, the computer-implemented method may include transmitting, via the one or more communication connections, one or more control instructions to control operation of the one or more physical objects. In some embodiments, the artificial intelligence vision system is trained to generate one or more enterprise insights based on one or more enterprise workflows, preferences of the user, historical usage patterns of the user, or some combination thereof, and the computer-implemented method includes automatically presenting the one or more enterprise insights in the digital twin virtual environment on the display of the computing device.

In some embodiments, the computing device includes an augmented reality device, virtual reality device, smartphone, laptop, tablet, goggles, monocle, glasses, or headset. In some embodiments, the one or more data sources includes one or more sensors, cameras, microphones, or some combination thereof. In some embodiments, each of the one or more virtual objects is associated with a current, historical, or projected state of a respective physical object. In some embodiments, the one or more visual elements enable viewing a chronological order of states associated with the respective physical object. In some embodiments, the computer-implemented method includes synchronizing the one or more virtual objects between a plurality of display areas associated with a set of applications concurrently presented on the display of the computing device. In some embodiments, the computer-implemented method includes synchronizing, using the artificial intelligence system, the one or more visual elements within the digital twin virtual environment concurrently presented via a plurality of computing devices associated with a plurality of users.

A tangible, computer-readable medium stores instructions that, when executed, cause one or more processing devices to receive, from one or more data sources, data associated with a physical environment including one or more physical objects. At least a subset of the one or more data sources may be disposed at the physical environment. The processing devices may, based on the data, generating, using an artificial intelligence vision system, a digital twin virtual environment representing the physical environment in real-time or near real-time. The digital twin virtual environment may include one or more virtual objects representing the one or more physical objects. The processing devices may cause presentation of the digital twin virtual environment on a display of a computing device, receiving, at the artificial intelligence vision system from one or more input devices, input from a user. The input may pertain to at least one of the one or more virtual objects. The processing devices may, based on the input, presenting, using the artificial intelligence vision system, one or more visual elements pertaining to recommendations, results, actions, or some combination thereof.

A system may include one or more memory devices storing instructions and one or more processing devices communicatively coupled to the one or more memory devices. The one or more processing devices may execute the instructions to receive, from one or more data sources, data associated with a physical environment including one or more physical objects. At least a subset of the one or more data sources may be disposed at the physical environment. The processing devices may, based on the data, generating, using an artificial intelligence vision system, a digital twin virtual environment representing the physical environment in real-time or near real-time. The digital twin virtual environment may include one or more virtual objects representing the one or more physical objects. The processing devices may cause presentation of the digital twin virtual environment on a display of a computing device, receiving, at the artificial intelligence vision system from one or more input devices, input from a user. The input may pertain to at least one of the one or more virtual objects. The processing devices may, based on the input, presenting, using the artificial intelligence vision system, one or more visual elements pertaining to recommendations, results, actions, or some combination thereof. In some embodiments, a computer-implemented method may include receiving, at an artificial intelligence vision system from a first device, one or more function calls, view state changes, or some combination thereof, identifying one or more synchronization elements based on the one or more received function calls, view state changes, or some combination thereof, generating, by the artificial intelligence vision system, one or more device synchronization instructions based on the one or more identified synchronization elements, and encoding the one or more device synchronization instructions. The method may include identifying, based on one or more access control rules, one or more second devices to receive the one or more encoded device synchronization instructions, and transmitting the one or more encoded device synchronization instructions to the one or more second devices to cause the one or more second devices to decode and execute the one or more encoded device synchronization instructions.

In some embodiments, the one or more synchronization elements are concurrently controlled on the first device and the one or more second devices. In some embodiments, the computer-implemented method includes generating, by the artificial intelligence vision system, one or more application synchronization instructions based on the one or more identified synchronization elements. In some embodiments, the computer-implemented method includes executing the one or more application synchronization instructions to cause the one or more synchronization elements to be controlled concurrently in one or more display areas associated with one or more enterprise applications presented on a display of the first device. In some embodiments, the computer-implemented method includes rendering a multi-dimensional virtual environment comprising the one or more synchronization elements. At least some of the one or more synchronization elements represent physical elements in a physical environment. In some embodiments, the computer-implemented method includes generating, using the artificial intelligence vision system, one or more enterprise insights. The method includes causing presentation of the one or more enterprise insights associated with the one or more synchronization elements. The method includes receiving, via one or more input devices, inputs pertaining to the one or more enterprise insights and, based on the inputs, performing one or more actions. In some embodiments, the one or more synchronization elements are associated with a chronological order of historical, current, and projected states, and the computer-implemented method includes presenting the chronological order in a multi-dimensional virtual environment.

An example tangible, non-transitory computer-readable medium stores instructions that, when executed, cause one or more processing devices to receive, at an artificial intelligence vision system from a first device, one or more function calls, view state changes, or some combination thereof, identify one or more synchronization elements based on the one or more received function calls, view state changes, or some combination thereof, generate, by the artificial intelligence vision system, one or more device synchronization instructions based on the one or more identified synchronization elements, and encode the one or more device synchronization instructions. The processing devices identify, based on one or more access control rules, one or more second devices to receive the one or more encoded device synchronization instructions, and transmit the one or more encoded device synchronization instructions to the one or more second devices to cause the one or more second devices to decode and execute the one or more encoded device synchronization instructions. A system may include one or more memory devices storing instructions and one or more processing devices communicatively coupled to the one or more memory devices. The one or more processing devices may execute the instructions to receive, at an artificial intelligence vision system from a first device, one or more function calls, view state changes, or some combination thereof, identify one or more synchronization elements based on the one or more received function calls, view state changes, or some combination thereof, generate, by the artificial intelligence vision system, one or more device synchronization instructions based on the one or more identified synchronization elements, and encode the one or more device synchronization instructions. The processing devices identify, based on one or more access control rules, one or more second devices to receive the one or more encoded device synchronization instructions, and transmit the one or more encoded device synchronization instructions to the one or more second devices to cause the one or more second devices to decode and execute the one or more encoded device synchronization instructions.

1. A computer-implemented artificial intelligence vision system method comprising:
generating, by one or more processing devices, a virtual spatial environment comprising one or more virtual objects depicting one or more enterprise assets associated with an enterprise machine-learning application, wherein the enterprise machine-learning application employs machine-learning to generate artificial intelligence insights associated with the one or more enterprise assets;
in response to receiving an input, causing, by the artificial intelligence vision system, presentation of one or more visual elements for an artificial intelligence insight associated with a particular virtual object, wherein the one or more visual elements indicate information regarding the corresponding enterprise asset of the particular virtual object.

2. The computer-implemented method of claim 1, wherein the one or more virtual objects rendered are based on one or more access control rules for a user.

3. The computer-implemented method of claim 1, wherein the enterprise machine-learning application uses one or more computer-implemented models trained to generate the one or more artificial intelligence insights based on one or more enterprise workflows, preferences of the user, historical usage patterns of the user, or some combination thereof.

4. The computer-implemented method of claim 1, further comprising synchronizing the one or more virtual objects between a plurality of display areas associated with a plurality of interfaces concurrently presented in a display of a computing device.

5. The computer-implemented method of claim 1, further comprising synchronizing, using the artificial intelligence vision system, the one or more visual elements within the virtual spatial environment presented via a plurality of computing devices associated with a plurality of users.

6. The computer-implemented method of claim 1, further comprising overlaying the virtual spatial environment at least partially on a physical environment visible through a computing device used by the user.

7. The computer-implemented method of claim 1, wherein the one or more artificial intelligence insights comprise statuses, alerts, messages, locations, parameters, values, vehicles, buildings, people, robots, machines, or some combination thereof.

8. The computer-implemented method of claim 1, further comprising:
receiving, via the one or more input devices, a selection of at least one of the one or more visual elements; and
transmitting, to one or more processing devices associated with the one or more physical objects, one or more control instructions to cause one or more modifications to operation of the one or more physical objects.

9. The computer-implemented method of claim 6, wherein the physical environment comprises one or more buildings, vehicles, rooms, robots, machines, or some combination thereof.

10. The computer-implemented method of claim 1, wherein the input comprises a query, and the method further comprises:
based on the query, identifying, using one or more large language models, at least a subset of the one or more artificial intelligence insights; and
rendering the virtual spatial environment comprising at least a subset of the one or more virtual objects associated with the subset of the one or more artificial intelligence insights.

11. The computer-implemented method of claim 1, wherein the input comprises limb gesture, appendage gesture, eye gaze, eye movement, head movement, voice, touch, noise, or some combination thereof.

12. A tangible, non-transitory computer-readable medium storing instructions that, when executed, cause one or more processing devices to:
receive, at the one or more processing devices executing an artificial intelligence vision system, one or more enterprise insights, wherein the one or more enterprise insights are generated via one or more computer-implemented models;
render, by the one or more processing devices, a multi-dimensional virtual environment comprising one or more virtual objects associated with the one or more enterprise insights, wherein the multi-dimensional virtual environment is rendered based on a digital twin of a physical environment representing at least one of a current, historical, and projected state of one or more physical objects;
receive, at the one or more processing devices from one or more input devices, input from the user, wherein the input pertains to the one or more virtual objects; and
based on the input, cause, using the artificial intelligence vision system, presentation of one or more visual elements pertaining to recommendations, results, actions, or some combination thereof, wherein the visual elements are generated via the one or more computer-implemented models.

13. The computer-readable medium of claim 12, wherein the one or more virtual objects rendered are based on one or more access control rules for the user.

14. The computer-readable medium of claim 12, wherein the one or more computer-implemented models are trained to generate the one or more enterprise insights based on one or more enterprise workflows, preferences of the user, historical usage patterns of the user, or some combination thereof.

15. The computer-readable medium of claim 12, wherein the one or more processing devices are further to synchronize the one or more virtual objects between a plurality of display areas associated with a plurality of applications concurrently presented in a display of a computing device.

16. The computer-readable medium of claim 12, wherein the one or more processing devices are further to synchronize, using the artificial intelligence vision system, the one or more visual elements within the multi-dimensional virtual environment presented via a plurality of computing devices associated with a plurality of users.

17. The computer-readable medium of claim 12, wherein the one or more processing devices are further to overlay the multi-dimensional virtual environment at least partially on a physical environment visible through a computing device used by the user.

18. The computer-readable medium of claim 12, wherein the one or more enterprise insights comprise statuses, alerts, messages, locations, parameters, values, vehicles, buildings, people, robots, machines, or some combination thereof.

19. The computer-readable medium of claim 12, wherein the one or more processing devices are further to:
receive, via the one or more input devices, a selection of at least one of the one or more visual elements; and
transmit, to one or more processing devices associated with the one or more physical objects, one or more control instructions to cause one or more modifications to operation of the one or more physical objects.

20. A system comprising:
one or more memory devices storing instructions; and
one or more processing devices communicatively coupled to the one or more memory devices, where the one or more processing devices execute the instructions to:
receive, at the one or more processing devices executing an artificial intelligence vision system, one or more enterprise insights, wherein the one or more enterprise insights are generated via one or more computer-implemented models;
render, by the one or more processing devices, a multi-dimensional virtual environment comprising one or more virtual objects associated with the one or more enterprise insights, wherein the multi-dimensional virtual environment is rendered based on a digital twin of a physical environment representing at least one of a current, historical, and projected state of one or more physical objects;
receive, at the one or more processing devices from one or more input devices, input from the user, wherein the input pertains to the one or more virtual objects; and
based on the input, cause, using the artificial intelligence vision system, presentation of one or more visual elements pertaining to recommendations, results, actions, or some combination thereof, wherein the visual elements are generated via the one or more computer-implemented models.
